(19) United States
(12) Patent Application Publication
(10) Pub. No.: US 2006/0172157 A1
(43) Pub. Date: Aug. 3, 2006

(54) Method for producing retardation film, and retardation film

(76) Inventor: Takashi Kuroda, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 11/317,803

(22) Filed: Dec. 27, 2005

(30) Foreign Application Priority Data
Dec. 28, 2004 (JP) 2004-382195

(51) Int. Cl. B32B 19/00

(52) U.S. Cl. 428/917; 428/690

(57) ABSTRACT

The present invention mainly provides a method for producing a retardation film having a small fluctuation of the optical compensation property and being relatively easy to produce. A method for producing a retardation film comprises: a coating process, wherein a coating liquid comprising a solvent and a material having refractive index anisotropy dissolved or dispersed therein is applied on a long continuous resin substrate; and a drying process, wherein the solvent in the coating liquid applied in the coating process is dried at temperature difference of the long continuous resin substrate in width direction within 10° C. at least until a remaining solvent amount in the coating liquid becomes 50 wt % or less.

### BACKGROUND OF THE INVENTION

1. Field of the Invention

The present invention relates to a method for producing a retardation film used in a state installed in a display device such as a liquid crystal display and the same, and the retardation film.

2. Description of the Related Art

As a conventional general liquid crystal display, as shown in FIG. 9, one comprising a polarizing plate 102A on an incident side, a polarizing plate 102B on an outgoing side and a liquid crystal cell 104 can be presented. The polarizing plates 102A and 102B are constructed so as to selectively transmit only the linear polarization having an oscillation surface in a predetermined oscillation direction (shown schematically by an arrow in the figure), and are disposed facing with each other in a cross nicol state such that the oscillation directions thereof have a relationship perpendicular with each other. Moreover, the liquid crystal cell 104 which contains a large number of cells corresponding to pixels is disposed in between the polarizing plate 102A and polarizing plate 102B.

Herein, a liquid crystal display 100, the liquid crystal cell 104 of which adopts a VA (Vertical Alignment) system wherein a nematic liquid crystal having a negative dielectric anisotropy is sealed (the liquid crystal director is shown schematically by a dotted line in the figure), is taken as an example. The linear polarization transmitted through the polarizing plate 102A on the incident side is transmitted without being its phase shifted at the time of being transmitted through a non-driven state cell part in the liquid crystal cell 104, and blocked by the polarizing plate 102B on the outgoing side. In contrast, at the time of being transmitted through a driven state cell part in the liquid crystal cell 104, the phase of the linear polarization is shifted so that light of an amount according to the phase shift amount is transmitted through and outgoes from the polarizing plate 102B on the outgoing side. Hence, by accordingly controlling the driving voltage of the liquid crystal cell 104 per each cell, a desired image can be displayed on the side of the polarizing plate 102B on the outgoing side. The liquid crystal display 100 is not limited to ones having the above-mentioned configuration of the light transmission and blockage. A liquid crystal display in which the outgoing light from the non-driven state cell part in the liquid crystal cell 104 is transmitted through and outgoes from the polarizing plate 102B on the outgoing side, and the outgoing light from the driven state cell part is blocked by the polarizing plate 102B on the outgoing side is also proposed.

Considering the case of the linear polarization transmitted through the non-driven state cell part in the liquid crystal cell 104 of the above-mentioned VA system, since the liquid crystal cell 104 has the double refraction property so that a refractive index in the thickness direction and a refractive index in the plane direction differ with each other, incident light along the normal line of the liquid crystal cell 104 among the linear polarization transmitted through the polarizing plate 102A on the incident side is transmitted without the phase being shifted. However, the incident light entering in an inclined direction from the normal line of the liquid crystal cell 104 among the linear polarization transmitted through the polarizing plate 102A on the incident side becomes elliptically polarized due to phase difference generated when the light is transmitted through the liquid crystal cell 104. This phenomenon is due to the liquid crystal molecules, oriented in the perpendicular direction in the liquid crystal cell 104, acting as a positive C plate. The magnitude of the phase difference of the light transmitted through the liquid crystal cell 104 (transmitted light) also depends on the double refractive value of the liquid crystal molecules sealed in the liquid crystal cell 104, the thickness of the liquid crystal cell 104, the wavelength of the transmitted light or the like.

Due to the above-mentioned phenomenon, even when a cell of the liquid crystal cell 104 is in the non-driven state so that the linear polarization is normally transmitted as it is and blocked by the polarizing plate 102B on the outgoing side, a part of the light, outgoing in the inclined direction from the normal line of the liquid crystal cell 104, is leaked from the polarizing plate 102B on the outgoing side.

Therefore, in the above-mentioned conventional liquid crystal display 100, there is a problem of a display quality deterioration of an image observed from the inclined direction from the normal line of the liquid crystal cell 104 (a problem of the visual angle dependency) mainly due to the contrast decline, compared with an image observed from the front side.

To improve the problem of the visual angle dependency in the above-mentioned conventional liquid crystal display 100, various techniques have been developed so far. For example, a stretched double refractive resin substrate is conventionally used as an optical compensating film. Also, for example, as disclosed in Japanese Patent Application Laid-Open (JP-A) Nos. Hei. 3-67,219 and Hei. 4-322,223, a liquid crystal display which uses a retardation layer (retardation layer showing the double refraction property) having a molecular structure of cholesteric regularity and disposes such a retardation layer between the liquid crystal cell and the polarizing plate so as to carry out an optical compensation is known. Further, for example, as disclosed in JP-A No. 10-312,166, a liquid crystal display which uses a retardation layer (retardation layer showing the double refraction property) comprising a disc like compound and disposes such a retardation layer between the liquid crystal cell and the polarizing plate so as to carry out an optical compensation is also known.

The conventional optical compensation film comprising stretched double refractive resin substrate and the conventional optical compensation film having a retardation layer can improve the problem of the visual angle dependency in certain degree. However, when producing the optical compensation film, particularly a fluctuation of the optical compensation property tends to occur easily in width direction perpendicular to a longitudinal direction (continuous conveying direction) of a long continuous film. Therefore, there are problems that liquid crystal displays, each of which has different display quality, may be produced, and that a liquid crystal display having different view angle depending on the position of a viewer's eye on a screen of the liquid crystal display may be produced.

In JP-A No. 2002-196,137, an optical compensation sheet which can optically compensate a surface of a liquid crystal cell uniformly by adjusting the stretching condition at production is disclosed. However, it is technically difficult to align in-plane optical axes of the optical compensation sheet. Particularly, since it is difficult to align axes of the stretching direction in the center part and end parts, there is a limit in improving a fluctuation of the optical compensation property of a long continuous film in the width direction by stretching technique.

### SUMMARY OF THE INVENTION

The present invention has been achieved in view of the above-mentioned problems, and an object thereof is mainly to provide a method for producing a retardation film having a small fluctuation of the optical compensation property and being relatively easy to produce.

In order to achieve the above-mentioned object, the present invention solves the above-mentioned problems by providing a method for producing a retardation film comprising steps of:

a coating process, wherein a coating liquid comprising a solvent and a material having refractive index anisotropy dissolved or dispersed therein is applied on a long continuous resin substrate; and

a drying process, wherein the solvent in the coating liquid applied in the coating process is dried at temperature difference of the long continuous resin substrate in width direction within 10° C. at least until a remaining solvent amount in the coating liquid becomes 50 wt % or less.

The present invention focuses mainly on controlling retardation by a material having refractive index anisotropy (hereinafter, it may be referred to as a refractive index anisotropic material). According to the present invention, the in-plane orientation of the material having refractive index anisotropy can be uniform by applying a coating liquid comprising a solvent and a material having refractive index anisotropy dissolved or dispersed therein on a long continuous resin substrate; and drying at temperature difference of a long continuous resin substrate in width direction within 10° C. at least until a remaining solvent amount in the coating liquid becomes 50 wt % or less in a drying process, wherein the solvent in the applied coating liquid is dried. Thereby, a retardation film having a small fluctuation of an optical compensation property can be obtained.

According to the production method of the present invention, it is preferable further to have an infiltration process, wherein the material having refractive index anisotropy is infiltrated into the long continuous resin substrate. In the case of coating a coating liquid comprising a solvent and a refractive index anisotropic material dissolved therein on the long continuous resin substrate so as to swell the long continuous resin substrate for infiltrating with the refractive index anisotropic material, the refractive index anisotropic material can be filled easily near a surface of the long continuous resin substrate, and thereby, a retardation film having a concentration gradient of the refractive index anisotropic material in a direction of the thickness of the long continuous resin substrate can be obtained. In this case, it is possible to easily change a retardation value of the retardation film by changing an amount or concentration of the coating liquid. Therefore, there is an advantage that a retardation film having a desired retardation value can be obtained easily by a small lot. Also, in this case, the retardation film of the present invention is not a retardation film comprising a substrate and a retardation layer laminated as a different layer on the substrate. Hence, there is an advantage that a problem such as peeling of the retardation layer from the substrate does not occur, which leads to higher reliability of heat resistance, water resistance or the like.

Also, according to the present invention, it is preferable that a fixing process, wherein the material having refractive index anisotropy infiltrated into the long continuous resin substrate is fixed, is provided after the above-mentioned drying process. For example, in the case of a refractive index anisotropic material having a polymerizable functional group, the refractive index anisotropic material can be prevented from exuding to a surface of a retardation film after producing the retardation film by infiltrating the refractive index anisotropic material into a long continuous resin substrate followed by polymerization, thereby, stability of the retardation film can be improved. Moreover, even in the case that a layer containing a refractive index anisotropic material is formed on a long continuous resin substrate in a form of layer, resistance of the layer containing the refractive index anisotropic material can be increased by polymerizing the refractive index anisotropic material.

In the production method of the present invention, there may be an orientation layer forming process, wherein an orientation layer is formed on the long continuous resin substrate, before the coating process. In this case, a layer containing a refractive index anisotropic material is formed on the orientation layer. A retardation value of a retardation film mainly changes by the layer containing the refractive index anisotropic material.

In this embodiment, it is preferable to have an orientation treatment process, wherein the layer containing the refractive index anisotropic material formed on the orientation layer in the coating process is subject to the orientation treatment since a retardation function is exhibited by orientation.

A retardation film according to the present invention is a retardation film having a layer containing a refractive index anisotropic material, wherein the layer is formed in such a manner that after applying a coating liquid comprising a solvent and a material having refractive index anisotropy dissolved or dispersed therein on a resin substrate, the solvent in the coating liquid is dried, and has the remaining solvent amount of 50 wt % or less. The retardation film of the present invention adjusts a retardation value by having the layer containing the refractive index anisotropic material, wherein the layer is formed in such a manner that after applying a coating liquid comprising a solvent and a material having refractive index anisotropy dissolved or dispersed therein on a resin substrate, the solvent in the coating liquid is dried, and has the remaining solvent amount of 50 wt % or less. In this way of adjusting the retardation value, since the layer containing the refractive index anisotropic material can be formed uniformly, a fluctuation in any direction parallel to the film surface can be made smaller than a case of adjusting a retardation value only by stretching a retardation film. Furthermore, when the remaining solvent amount is high, a surface of a side having the layer containing the refractive index anisotropic material is fogged so that the light transmittance of the film may be lowered. However, the retardation film according to the present invention has the layer containing the refractive index anisotropic material, a remaining solvent amount of which is 50 wt % or less, hence, the retardation film according to the present invention can lower a haze value of the surface of the side having the layer containing the refractive index anisotropic material and prevent decrease of the light transmittance so as to have a high transparency. From the viewpoint of improving transparency even more, the remaining solvent amount of the layer containing the refractive index anisotropic material may be preferably 10 wt % or less, more preferably 1 wt % or less.

The retardation film of the present invention preferably has a fluctuation of an in-plane retardation (Re) of the retardation film measured at 550 nm wavelength in any direction parallel to a film surface within the range of ±5 nm based on the average of the Re, and has a fluctuation of a thickness direction retardation (Rth) of the retardation film measured at 550 nm wavelength in any direction parallel to the film surface within the range of ±5 nm based on the average of the Rth. By having a small fluctuation as above, for example, when applying the retardation film to a display device as an optical compensation film, the inside of a display screen can be uniformly optically compensated so that a display device excellent in display quality such as visual angle or the like can be obtained.

In the present invention, it is preferable that the layer containing the refractive index anisotropic material is formed in the resin substrate. In this case, it is possible to easily change a retardation value of the retardation film by changing an amount and concentration of the coating liquid since the layer containing the refractive index anisotropic material becomes a retardation reinforcing region. Therefore, there is an advantage that a retardation film having a desired retardation value can be obtained easily by a small lot. Also, in this case, the retardation film of the present invention is not a retardation film comprising a substrate and a retardation layer laminated as a different layer on the substrate. Hence, there is an advantage that a problem such as peeling of the retardation layer from the substrate does not occur, which leads to higher reliability of heat resistance, water resistance or the like.

Also, in the present invention, the material having refractive index anisotropy may have a concentration gradient in a thickness direction of the resin substrate. In the case that the layer containing the refractive index anisotropic material is formed in the resin substrate, the material having refractive index anisotropy has a concentration gradient in a thickness direction of the resin substrate.

In the present invention, the layer containing the refractive index anisotropic material may be formed on the orientation layer on the resin substrate. In this case, a retardation value of the retardation film is mainly changed by the layer containing a refractive index anisotropic material.

Moreover, according to the present invention, it is preferable that the resin substrate has regularity in the refractive index. Particularly, when the layer containing a refractive index anisotropic material is formed in the resin substrate, the refractive index regularity of the resin substrate can be reinforced by the refractive index anisotropic material to be filled, so that a retardation film having various characteristics can be obtained.

According to the present invention, it is preferable that the refractive index anisotropic material is a material having liquid crystallinity. With the material having liquid crystallinity, a liquid crystal structure may be provided when the material is filled in the resin substrate so that the effect can be imparted effectively to the resin substrate. Also, if the refractive index anisotropic material is the material having liquid crystallinity, when the layer containing the refractive index anisotropic material is formed to orient on the orientation layer, for example, the layer containing the refractive index anisotropic material may be a retardation layer exhibiting a double refraction property.

Furthermore, according to the present invention, it is preferable that a molecular structure of the refractive index anisotropic material is in a shape of a rod. With the use of the refractive index anisotropic material having a structure in the shape of a rod, for example, when the refractive index anisotropic material is filled in the resin substrate, the refractive index regularity of the resin substrate can be reinforced. Also, when the layer containing a refractive index anisotropic material containing a chiral agent is formed on the orientation layer, the layer containing a refractive index anisotropic material shows the cholesteric regularity and can be, for example, a retardation layer exhibiting a double refraction property.

In the present invention, it is preferable that the material having refractive index anisotropy has a cholesteric structure or a discotic structure. In this case, a so-called negative C plate having refractive index anisotropy, in which a refractive index of the direction perpendicular to the retardation layer is smaller than a refractive index in any direction parallel to a surface of the retardation layer, can be suitably obtained.

Furthermore, according to the present invention, it is preferable that the material having refractive index anisotropy contains a polymerizable functional group. The refractive index anisotropic material is polymerized with the use of the polymerizable functional group after the resin substrate is filled with the material having refractive index anisotropy, or after the layer containing the refractive index anisotropic material is formed on the orientation layer. Thereby, exudation of the refractive index anisotropic material after a retardation film is formed can be prevented and resistance can be imparted, thus, a stable retardation film can be provided.

### BRIEF DESCRIPTION OF THE DRAWINGS

In the accompanying drawings,

FIGS. 1A to 1C are process diagrams showing an example of a first embodiment of a method for producing a retardation film of the present invention;

FIG. 2A is a schematic view showing an example of a drying process of the present invention;

FIG. 2B is a schematic view showing another example of a drying process of the present invention;

FIGS. 3A to 3E are process diagrams showing an example of a second embodiment of a method for producing a retardation film of the present invention;

FIG. 4 is a schematic cross sectional view showing an example of a first embodiment of a retardation film of the present invention;

FIGS. 5A to 5E are graphs schematically showing the concentration gradient distributions;

FIG. 6 is a process diagram showing an example of a method for producing a retardation film of the present invention;

FIG. 7 is a TEM photograph showing a cross section of the retardation film of example 1;

FIG. 8A is a schematic view showing an example of a drying process of comparative example of the present invention;

FIG. 8B is a schematic view showing an example of a drying process of comparative example of the present invention; and

FIG. 9 is a schematic exploded perspective view showing a conventional liquid crystal display.

The sign in each figure refers to the following: 1: a resin substrate, 2: a retardation reinforcing region forming coating liquid, 3: a retardation reinforcing region, 4: a substrate region, 5: ultraviolet rays, 6: a retardation film, 7: a drying zone, 8: a substrate conveying direction, 9: a width direction, 10(1), 10(2), 10(3): a drying zone, 11(1), 11(2), 11(3): a drying zone, 12: an orientation layer, 13: a retardation layer forming coating liquid, 14: a layer containing a refractive index anisotropic material, 15: a retardation layer, 16: a surface side, and 17: a side opposite to a surface side, 18(1), 18(2), 18(3): a drying zone, 19(1), 19(2), 19(3), 19(4): a drying zone.

### DESCRIPTION OF THE PREFERRED EMBODIMENT

The present invention includes a method for producing a retardation film and a retardation film. Hereinafter, each of them will be explained in detail.

A. Production of Retardation Film

First, a method for producing a retardation film of the present invention will be explained.

A method for producing a retardation film according to the present invention comprises:

a coating process, wherein a coating liquid comprising a solvent and a material having refractive index anisotropy dissolved or dispersed therein is applied on a long continuous resin substrate; and

a drying process, wherein the solvent in the applied coating liquid in the coating process is dried at temperature difference of the long continuous resin substrate in width direction within 10° C. at least until a remaining solvent amount in the coating liquid becomes 50 wt % or less.

In the present invention “on a long continuous resin substrate” may be “directly on a long continuous resin substrate” or “on a long continuous resin substrate via other layer”.

Embodiments of the method for producing a retardation film of the present invention vary depending on where to apply the above-mentioned coating liquid on the long continuous resin substrate. Each embodiment of the method for producing a retardation film will be hereinafter explained.

### 1. First Embodiment

A first embodiment of a method for producing a retardation film of the present invention is an embodiment that a coating liquid comprising a solvent and a material having refractive index anisotropy dissolved or dispersed therein is applied directly on a long continuous resin substrate.

In such a case of applying a coating liquid directly on a long continuous resin substrate, the coating liquid makes the resin substrate swell for infiltrating with a refractive index anisotropic material so that the refractive index anisotropic material can be easily filled near a surface in the resin substrate, and thereby, a region containing the refractive index anisotropic material (hereafter referred as a layer containing a refractive index anisotropic material or a retardation reinforcing region) can be formed in the long continuous resin substrate. In the first embodiment, it is possible to easily change a retardation value of the retardation film by the layer containing the refractive index anisotropic material (retardation reinforcing region) by changing an amount or concentration of the coating liquid. Hence, there is an advantage that a retardation film having a desired retardation value can be easily obtained by a small lot. Also, in this case, the retardation film of the present invention is not a retardation film comprising a substrate and a retardation layer laminated on the substrate. Hence, there is an advantage that a problem such as peeling of the retardation layer from the substrate does not occur, which leads to higher reliability of heat resistance, water resistance or the like.

As mentioned above, the first embodiment further has an infiltration process, wherein the material having refractive index anisotropy is infiltrated into the long continuous resin substrate. In the first embodiment, the coating liquid comprising a solvent and a material having refractive index anisotropy dissolved or dispersed therein forms the retardation reinforcing region in the resin substrate. Thus, hereinafter, the coating liquid of the first embodiment will be referred as a retardation reinforcing region forming coating liquid.

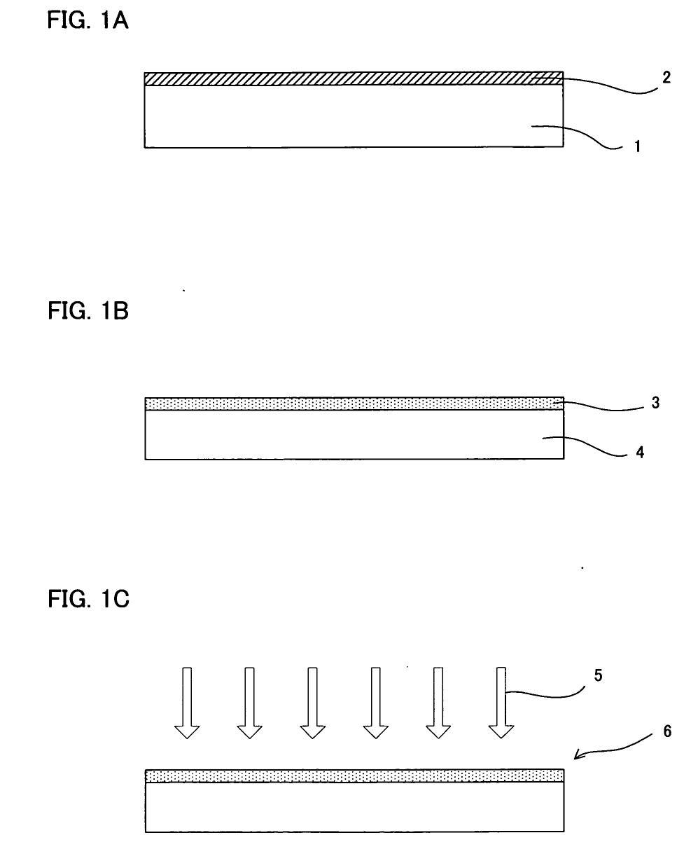

FIGS. 1A to 1C are process diagrams showing an example of the method for producing a retardation film of the present invention. First, as shown in FIG. 1A, a coating process, wherein a retardation reinforcing region forming coating liquid 2 is applied on a resin substrate 1, is performed. Next, as shown in FIG. 1B, an infiltration process, wherein the refractive index anisotropic material in the retardation reinforcing region forming coating liquid is infiltrated into the resin substrate, and a drying process, wherein a solvent in the retardation reinforcing region forming coating liquid applied in the coating process is dried, are performed. The drying process according to the present invention dries at temperature difference of the long continuous resin substrate in width direction within 10° C. at least until a remaining solvent amount in the coating liquid becomes 50 wt % or less. Thereby, the refractive index anisotropic material in the retardation reinforcing region forming coating liquid is infiltrated from the resin substrate surface so that a retardation reinforcing region 3 containing the refractive index anisotropic material on the surface side of the resin substrate is formed. As a result, the retardation reinforcing region 3, which contains the refractive index anisotropic material, and a substrate region 4, which does not contain the refractive index anisotropic material, are formed in the resin substrate. Finally, as shown in FIG. 1C, a retardation film 6 is formed by performing a fixing process, wherein the refractive index anisotropic material contained in the resin substrate is polymerized by irradiating with ultraviolet rays 5 from the retardation reinforcing region 3 side.

Hereinafter, the first embodiment of the method for producing a retardation film of the present invention will be explained by each step.

(1) Coating Process

A coating process in the present invention is a process, wherein a coating liquid comprising a solvent and a material having refractive index anisotropy dissolved or dispersed therein is applied on a long continuous resin substrate. Particularly, in the first embodiment, the coating process is a process of applying a retardation reinforcing region forming coating liquid, in which a refractive index anisotropic material is dissolved or dispersed in a solvent, directly at least on one surface of a long continuous resin substrate.

In the first embodiment of the present invention, it is possible to change a retardation value of the retardation film by changing a coating amount of the retardation reinforcing region forming coating liquid in the coating process.

Both surfaces of the long continuous resin substrate may be coated according to the coating process.

The long continuous resin substrate used in the present invention is not particularly limited. In general, a long continuous resin substrate made of a resin capable of transmitting light in the visible light range is suitably used. Herein, “transmitting light in the visible light range” means the case that an average light transmittance in the visible light range of 380 to 780 nm is 50% or more, preferably 70% or more, and more preferably 85% or more. For the light transmittance, a value measured by an ultraviolet-visible spectrophotometer (for example, UV-3100PC manufactured by Shimadzu Corporation) at room temperature in the atmosphere is used.

As the resin substrate used in the present invention, a resin substrate having the refractive index regularity is preferable. Although it is less clear yet, it is assumed that the retardation film in the first embodiment of the present invention exhibits a function as an optical functional film such as an optical compensating plate and the like, by obtaining a larger retardation value, for the following reasons. That is, it is assumed that, when the refractive index anisotropic material is filled in the resin substrate, the filled refractive index anisotropic material reinforces the refractive index regularity such as a double refraction property and the like inherent to the resin substrate, and thereby, a retardation film having various characteristics can be obtained. Therefore, as the resin substrate used in the present invention, a resin substrate having some kind of refractive index regularity is suitably used.

The refractive index regularity in the present invention is that, for example, (1) the resin substrate acts as a negative C plate, (2) the resin substrate has a characteristic of an A plate or a biaxial plate, or the like.

Moreover, in the first embodiment, it is preferable that the resin substrate has high swelling degree to a predetermined solvent. This is because the above-mentioned refractive index anisotropic material is infiltrated and filled in the resin substrate by applying the retardation reinforcing region forming coating liquid comprising a solvent and the refractive index anisotropic material dissolved or dispersed therein onto the surface of the resin substrate and swelling by the solvent. Specifically, it is preferable that the resin substrate is swelled when the resin substrate is soaked in a certain solvent. This phenomenon can be determined visually. For example, swelling property to a solvent can be confirmed by forming a resin substrate (film thickness: several μm), dropping a solvent thereon, and observing the infiltration condition of the solvent.

As materials for such a resin substrate, specifically, there may be a cellulose based resin or the like. In particular, cellulose ester is preferable, and cellulose acetate is more preferable. Among the above, TAC (cellulose triacetate) is a particularly preferable resin.

A film thickness of the resin substrate used in the present invention is not particularly limited, and it can be selected accordingly. Therefore, a film referred to in the present invention is not limited to a so-called film in a narrow sense but it also includes a film having a film thickness in the range of a so-called sheet or plate. However, in general, a film having a relatively thin film thickness is used. Generally, a film having a film thickness in the range of 10 μm to 200 μm, and in particular in the range of 20 μm to 100 μm can be suitably used.

A fluctuation of an in-plane and a thickness direction retardation of the retardation film in any direction parallel to the film surface hereinafter described depends on a resin substrate to be used. In order to decrease the fluctuation, it is preferable that a resin substrate to be used has a fluctuation of an in-plane retardation (Re) in any direction parallel to a film surface measured at 550 nm wavelength within the range of ±5 nm based on the average of Re, and has a fluctuation of a thickness direction retardation (Rth) in any direction parallel to the film surface measured at 550 nm wavelength within the range of ±5 nm based on the average of Rth.

On the other hand, the retardation reinforcing region forming coating liquid used in the present invention contains at least a solvent and a refractive index anisotropic material dissolved or dispersed in the solvent. Other additives may be added, if necessary.

As the refractive index anisotropic material used for the retardation reinforcing region forming coating liquid, there may not be particularly limited, if a material can be filled in the resin substrate and has a double refraction property.

In the first embodiment of the present invention, a material having relatively small molecular weight is suitably used since such a material can be easily filled in a resin substrate. Specifically, a material having a molecular weight in the range of 200 to 1,200, in particular, in the range of 400 to 800 may be suitably used. The molecular weight here refers to a molecular weight before polymerization for the below mentioned refractive index anisotropic material having a polymerizable functional group to be polymerized in the resin substrate.

As the refractive index anisotropic material used in the first embodiment of the present invention, it is preferable that a molecular structure of the material is in a shape of a rod. This is because the material in a shape of a rod can enter into a gap in the resin substrate relatively easily.

Moreover, it is preferable that the refractive index anisotropic material used in the present invention is a material having a liquid crystallinity (liquid crystalline molecule). If the refractive index anisotropic material is the liquid crystalline molecule, when the refractive index anisotropic material is filled in the resin substrate, the refractive index anisotropic material can be in a liquid crystalline state in the resin substrate so that a double refraction property of the refractive index anisotropic material can be reflected to the retardation film more effectively.

In the present invention, as the refractive index anisotropic material, a nematic liquid crystalline molecule material, a cholesteric liquid crystalline molecule material, a smectic liquid crystalline molecule material, and a discotic liquid crystalline molecule material can be used. Among them, it is preferable that the refractive index anisotropic material is the nematic liquid crystalline molecule material. In the case of the nematic liquid crystalline molecule material, since several to several hundreds of the nematic liquid crystalline molecules, which have entered into the gap in the resin substrate, are oriented in the resin substrate, the refractive index anisotropy can be exhibited more certainly. It is particularly preferable that the above-mentioned nematic liquid crystalline molecule is a molecule having spacers on both mesogen ends. Since the nematic liquid crystalline molecule having spacers on both mesogen ends has flexibility, white turbidity caused upon getting into the gap in the resin substrate can be prevented.

As the refractive index anisotropic material used in the present invention, a refractive index anisotropic material having a polymerizable functional group in the molecule is suitably used. In particular, a refractive index anisotropic material having the polymerizable functional group which can be three-dimensionally cross-linked is preferable. If the refractive index anisotropic material having the polymerizable functional group is used, the refractive index anisotropic material can be polymerized (cross-linked) in the resin substrate after being filled in the resin substrate, by the function of the radical generated from a photo-polymerization initiator due to a light radiation, by the function of the electron beam or the like. Therefore, problems such as exudation of the refractive index anisotropic material after being formed as a retardation film can be prevented so that a retardation film which can be used stably can be provided. “Three-dimensionally cross-linked” means a state that the liquid crystalline molecules are polymerized three dimensionally with each other so as to be a mesh (network) structure.

The polymerizable functional group is not particularly limited. Various kinds of polymerizable functional groups to be polymerized by a function of ionizing radiation such as ultraviolet ray, electron beam and the like, or heat can be used. As representative examples of the polymerizable functional group, there may be a radical polymerizable functional group, a cationic functional group or the like. Furthermore, as the representative examples of the radical polymerizable functional group, there may be a functional group having at least one ethylenically unsaturated double bond capable of addition polymerization. Specifically, for example, there may be a vinyl group, an acrylate group (it is a general term including an acryloyl group, a methacryloyl group, an acryloyloxy group, and a methacryloyloxy group) or the like with or without a substituent. As a specific example of a cationic polymerizable functional group, there may be an epoxy group or the like. Also, as a polymerizable functional group, for example, there may be an isocyanate group, an unsaturated triple bond or the like. Among them, from the viewpoint of the process, the functional group having an ethylenically unsaturated double bond can be suitably used.

In the first embodiment of the present invention, among the above, a liquid crystalline molecule, whose molecular structure is in a shape of a rod, and having the above-mentioned polymerizable functional group on its end can be particularly suitably used. For example, by using a nematic liquid crystalline molecule having one or more polymerizable functional groups on both ends, the molecules can be polymerized with each other three-dimensionally so as to provide a mesh (network) structure state. Therefore, a stronger resin substrate can be obtained.

Specifically, a liquid crystalline molecule having an acrylate group on its end may be suitably used. The specific examples of the nematic liquid crystalline molecule having an acrylate group on its end are represented in the following chemical formulae (1) to (6):

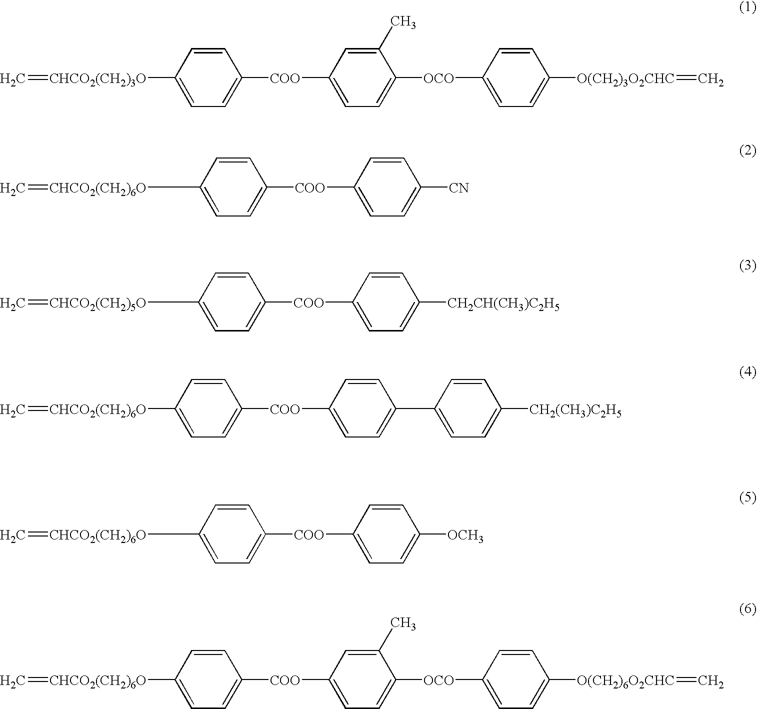

Herein, the liquid crystalline molecules represented by the chemical formulae (1), (2), (5) and (6) can be prepared according to the methods disclosed in Makromol Chem. 190, 3201-3215 (1989) by D. J. Broer, et al., Makromol Chem. 190, 2250 (1989) by D. J. Broer, et al., or a method similar there to. Also, the preparation of the liquid crystalline molecules represented by the chemical formulae (3) and (4) is disclosed in DE 195,04,224.

Moreover, there may also be, specifically for example, the nematic liquid crystalline molecules having an acrylate group on its end represented by the following chemical formulae (7) to (17):

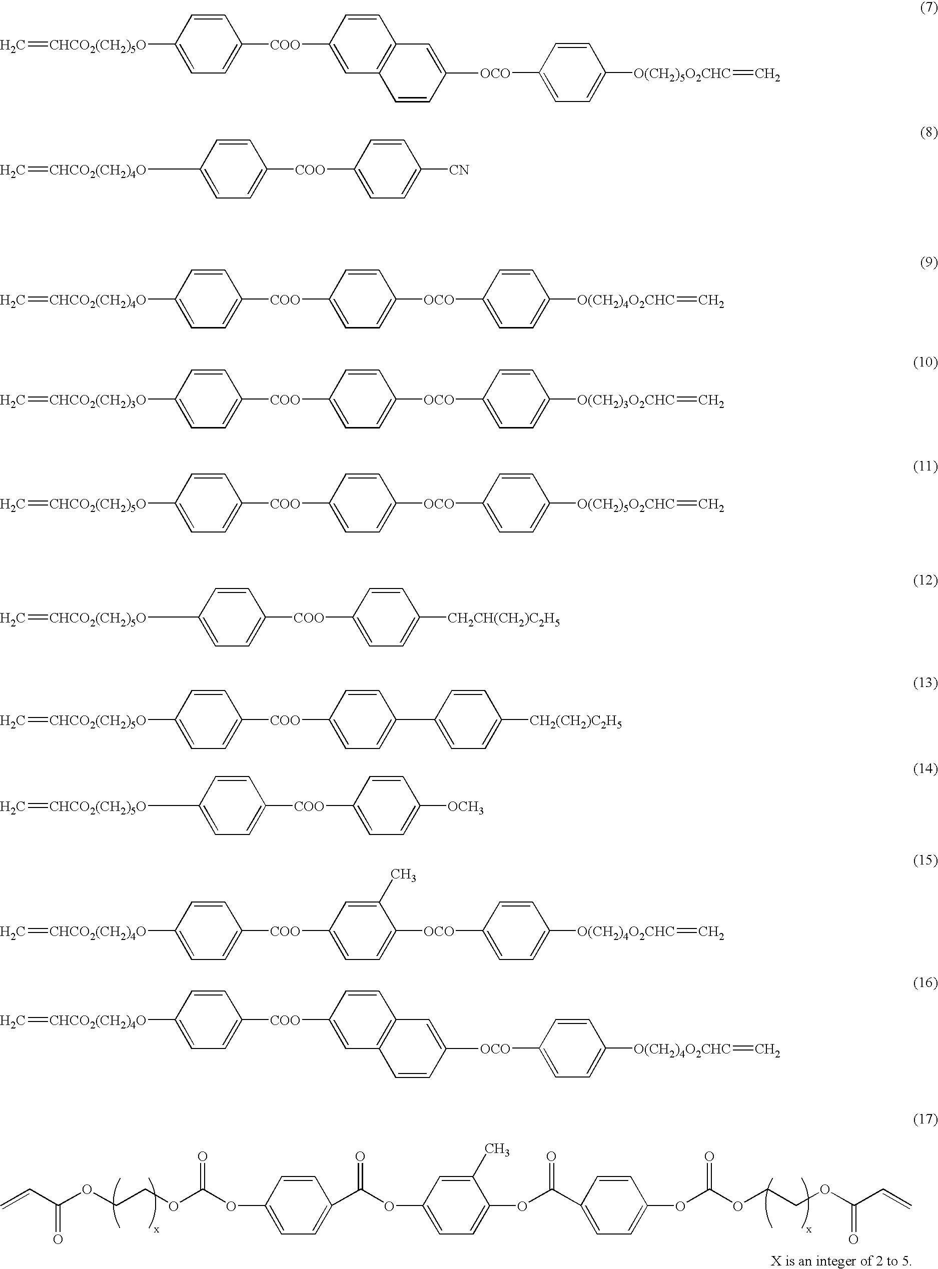

The refractive index anisotropic material of the present invention may be used by two or more kinds. Particularly, as the refractive index anistropic material of the first embodiment in the present invention, from the viewpoint of reinforcing the retardation function and improving reliability of the film, it is preferable to use both a liquid crystalline molecule having the polymerizable functional group with a molecular structure in a shape of a rod and a liquid crystalline molecule not having the polymerizable functional group with a molecular structure in a shape of a rod. Particularly, it is preferable to use a liquid crystalline molecule having the polymerizable functional group on both ends with a molecular structure in a shape of a rod, a liquid crystalline molecule having the polymerizable functional group on one end with a molecular structure in a shape of a rod, and a liquid crystalline molecule not having the polymerizable functional group on both ends with a molecular structure in a shape of a rod. This is because a liquid crystalline molecule not having the polymerizable functional group in a shape of a rod infiltrates into the resin substrate more easily and/or orients in the resin substrate more easily, thus the retardation function can be reinforced more easily. On the other hand, by mixing liquid crystalline molecules having the polymerizable functional group in a shape of a rod to enable polymerization between molecules, a property to prevent exudation of molecules, resistance such as solvent resistance, heat resistance and the like can be imparted.

When the refractive index anisotropic material has a polymerizable functional group and the below-mentioned fixing process (process of polymerizing the refractive index anisotropic material) is carried out in the producing process of the retardation film, the refractive index anisotropic material contained in the retardation film is polymerized by a predetermined polymerization degree, thus, strictly speaking, the refractive index anisotropic material is different from that used for the retardation reinforcing region forming coating liquid.

Moreover, the solvent used for the above-mentioned retardation reinforcing region forming coating liquid is not particularly limited as long as it is a solvent capable of sufficiently swelling the resin substrate and capable of dissolving or dispersing the refractive index anisotropic material. Specifically, when the resin substrate is TAC and the refractive index anisotropic material is the nematic liquid crystal having acrylate on its end, cyclohexanone may be suitably used.

As the additive, specifically for example, there may be a photo polymerization initiating agent or the like when a photo polymerizable type refractive index anisotropic material is used. Also, there may be a polymerization inhibiting agent, a leveling agent, a chiral agent, a silane coupling agent or the like.

The concentration of the refractive index anisotropic material in the solvent, in the retardation reinforcing region forming coating liquid of the present invention, may not be particularly limited. Generally, the concentration of the refractive index anisotropic material is preferable in the range of 5 wt % to 40 wt %, and particularly in the range of 15 wt % to 30 wt %.

Moreover, although the coating amount onto the resin substrate of the first embodiment differs depending on the retardation value required for the obtained retardation film, it is preferable that the coating amount of the refractive index anisotropic material after drying is in the range of 0.8 g/m² to 8 g/m², and particularly preferably in the range of 1.6 g/m² to 5 g/m².

The coating method in this process is not particularly limited as long as it is a method capable of applying the retardation reinforcing region forming coating liquid evenly onto the resin substrate surface. There may be a method such as bar coating, blade coating, spin coating, die coating, slit reverse, roll coating, dip coating, an ink jet method, a micro gravure method and the like. In the present invention, it is particularly preferable to use the blade coating, the die coating, the slit reverse and the roll coating.

(2) Drying Process and Infiltration Process

A drying process in the present invention is a process, wherein the solvent in the coating liquid applied in the coating process is dried at temperature difference of the long continuous resin substrate in width direction within 10° C. at least until a remaining solvent amount in the coating liquid becomes 50 wt % or less.

In the first embodiment of the present invention, after the above-mentioned coating process, an infiltration process, wherein the refractive index anisotropic material in the retardation reinforcing region forming coating liquid applied in the coating process is infiltrated into the resin substrate; and a drying process, wherein the solvent in the retardation reinforcing region forming coating liquid applied in the coating process is dried, are carried out. The infiltration process, which is a process of leaving the resin substrate after coating so that the refractive index anisotropic material is sufficiently infiltrated and taken into the resin substrate, may be carried out simultaneously with the drying process depending on the kind of the solvent to be used or the like.

“The remaining solvent amount” in the present invention means an amount of the solvent remaining in the coating liquid applied on the resin substrate, which is represented by ratio with respect to the amount of the solvent in the coating liquid at the time of coating as 100 wt %.

The remaining solvent amount in the present invention can be obtained in the following manner. Firstly, the coating liquid used in the coating process right after coating is sampled in a weighing bottle as Sample 1. A weight A1 of Sample 1 is weighed. Then, after Sample 1 is heated at temperature and time which a solvent can volatilize, for example, heating at 110° C. for 1 hour, so as to volatilize a solvent, Sample 1 is cooled to room temperature so as not to absorb moisture. A weight B1 of the dried Sample 1 is weighted. C1 is determined by A1−Bl=C1. Next, a weight A2 of Sample 2, which is sampled at desired measuring point on the substrate to measure a remaining solvent amount, and a weight B2 of Sample 2 after drying is similarly weighted. C2 is determined by A2−B2=C2. Herein, B1 and B2, each of which is a solid content other than the solvent, need to be the same amount in order to compare the amounts of the solvent. Thus, a solvent amount C2′, which is an amount of the solvent when B1 and B2, each of which is a solid content other than the solvent, are the same amount, is calculated by C2′=C2×B1/B2. Using C1 and C2′ mentioned above, according to the following formula, the remaining solvent amount (wt %) can be calculated.
Remaining solvent amount (wt %)=C2′/C1×100

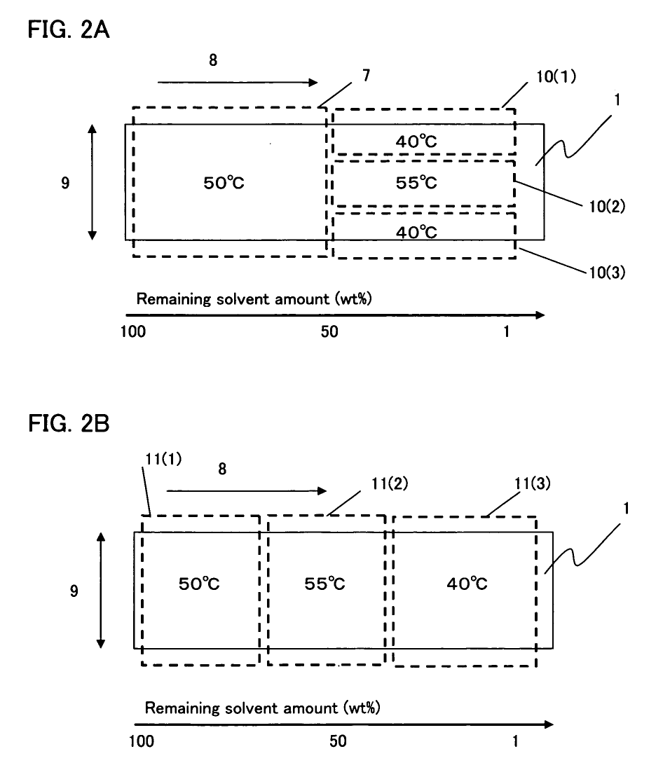

In the present invention, to “dry at temperature difference of the long continuous resin substrate in width direction within 10° C. until a remaining solvent amount in the coating liquid becomes 50 wt % or less” includes the case wherein, for example as schematically shown in FIG. 2A, drying is performed without temperature difference in width direction 9 perpendicular to a longitudinal direction (substrate continuous conveying direction) 8 of a long continuous resin substrate 1 until a drying zone 7 where a remaining solvent amount in the coating liquid becomes 50 wt % or less, and after the remaining solvent amount becomes 50 wt % or less, temperature difference in width direction of the long continuous resin substrate in a drying zone 10, for example, among 10(1), 10(2) and 10(3), is larger than 10° C. Also, as schematically shown in FIG. 2B, the case, wherein there is no temperature difference in the width direction 9 of the long continuous resin substrate 1, and temperature difference in the width direction of the long continuous resin substrate and the temperature difference in each drying zone 11(1), 11(2) and 11(3) of the longitudinal direction (substrate continuous conveying direction) 8 of the long continuous resin substrate is larger than 10° C., may be included. Moreover, the case, wherein the whole drying process is performed at temperature difference in width direction of the long continuous resin substrate within 10° C., may be included.

In order to uniform the fluctuation of refractive index anisotropy (optical compensation property) of the produced retardation film, basically, it is also necessary to carry out a drying process in the longitudinal direction of the long continuous resin substrate at temperature difference within 10° C. until the remaining solvent amount becomes 50 wt % or less. However, as for the longitudinal direction, even if there is a temperature distribution of 10° C. or more along the longitudinal direction but the temperature distribution is steady in terms of time, contribution of a drying temperature to orientation of the refractive index anisotropic material is averaged with conveyance of the long continuous resin substrate. Hence, even if there is the temperature distribution of 10° C. or more along the longitudinal direction, there is no problem in uniforming the fluctuation of the optical compensation property. Also, due to thermal inertia of a drying device in practice, the temperature distribution may be considered to be steady largely longer than the time that a retardation plate of a size used for one display device passes the drying device. Thus, practically in most cases, the condition of keeping the temperature difference of the longitudinal direction within 10° C. until the remaining solvent amount becomes 50 wt % or less is met without taking the temperature distribution of the longitudinal direction into account in particular.

On the other hand, as for the width direction of the long continuous resin substrate, if a boundary condition of the drying device in the center part and that at the side end part are different, there is always a systematic temperature distribution, for example, a pattern that the temperature is lower in the center part than at the both side end parts throughout inside of the drying device. Hence, the contribution of the drying temperature to orientation of the refractive index anisotropic material cannot be averaged with conveyance of the long continuous resin substrate.

Therefore, upon production, it is necessary to control the drying temperature distribution of the width direction of the long continuous resin substrate.

In the drying process of the present invention, drying is performed at temperature difference of a long continuous resin substrate in width direction within 10° C. at least until a remaining solvent amount in the coating liquid applied becomes 50 wt % or less. It is further preferable to dry at temperature difference within 10° C., preferably within 5° C., particularly preferably within 1° C., at least until the remaining solvent amount in the coating liquid applied becomes 10 wt % or less, particularly 1 wt % or less, from the viewpoint of further decreasing the fluctuation of retardation value in the surface direction.

In the above-mentioned drying process, the temperature and the time may vary drastically depending on a kind of solvent to be used and whether or not the drying process is carried out simultaneously with the infiltration process. For example, when cyclohexanone is used as the solvent and the drying process is carried out simultaneously with the infiltration process, the drying process is carried out at temperature generally in the range of room temperature to 120° C., preferably in the range of 70° C. to 100° C., and for the time of about 30 seconds to 10 minutes, preferably about 1 minute to 5 minutes.

As a drying method, for example, there may be drying under reduced pressure or heat drying. Further, there may be a combination of these drying methods or the like.

In the infiltration process, it is preferable that 90 wt % or more, preferably 95 wt % or more, particularly preferably 100 wt %, of the refractive index anisotropic material in the above-mentioned retardation reinforcing region forming coating liquid is infiltrated and taken into the resin substrate. In the case that a large amount of the refractive index anisotropic material remains on the resin substrate surface without being infiltrated into the resin substrate, the surface of the film is fogged so that the light transmittance of the film may be lowered.

Therefore, it is preferable that the resin substrate after the infiltration and drying processes has the haze value measured in accordance with JIS-K7105 of the surface on the infiltration side of 10% or less, more preferably 2% or less, and particularly preferably 1% or less.

(3) Fixing Process

Further, when the refractive index anisotropic material used has a polymerizable functional group, a fixing process is carried out for polymerizing the refractive index anisotropic material. By carrying out the fixing process as mentioned above, exudation of the refractive index anisotropic material, once taken into the resin substrate, can be prevented so that the stability of the obtained retardation film can be improved.

For the fixing process in the present invention, various methods are used depending on the refractive index anisotropic material to be used. For example, when the refractive index anisotropic material is a photocurable compound, a photo polymerization initiator is contained and ultraviolet rays or electron beams is irradiated, and when it is a thermosetting compound, it is heated.

Each process may be carried out for two or more times. For example, a retardation film may be formed in the following manner. First, a coating process, wherein a first retardation reinforcing region forming coating liquid is applied on a resin substrate, is performed, then a infiltration process, wherein a first refractive index anisotropic material in the first retardation reinforcing region forming coating liquid is infiltrated into the resin substrate, and a drying process, wherein a solvent in the first retardation reinforcing region forming coating liquid is dried, are performed. Next, a coating process, wherein a second retardation reinforcing region forming coating liquid is further applied on the surface side to which the first retardation reinforcing region forming coating liquid is applied, is performed, then a infiltration process, wherein a second refractive index anisotropic material in the second retardation reinforcing region forming coating liquid is infiltrated, and a drying process, wherein a solvent in the second retardation reinforcing region forming coating liquid is dried, are performed followed by a fixing process, wherein fixing is performed from the side where the second retardation reinforcing region forming coating liquid is applied. In this case, for example, by using a rod like liquid crystalline molecule having no polymerizable functional group to be easily infiltrated into the polymer film is used as the first refractive index anisotropic material and a rod like liquid crystalline molecule having a polymerizable functional group is used as the second refractive index anisotropic material, the resin substrate is formed so that a region containing a rod like liquid crystalline molecule having no polymerizable functional group capable of easily reinforcing the retardation and a region containing a rod like liquid crystalline molecule having the polymerizable functional group at a side closer to a surface coexist. Hence, the resin substrate can have effects to have further reinforced retardation, and at the same time, to stabilize the resin substrate surface by polymerization in the fixing process. If a rod like liquid crystalline molecule having less polymerizable functional groups is used as the first refractive index anisotropic material and a rod like liquid crystalline molecule having more polymerizable functional groups is used as the second refractive index anisotropic material, the same effect as above can be obtained.

Also, there may be a process of further applying a coating liquid in which a material which is not the refractive index anisotropic material but has a polymerizable functional group is dissolved or dispersed, a drying process of the coating liquid, and further a polymerization process of the polymerizable functional group after the above-mentioned coating process wherein the retardation reinforcing region forming coating liquid is applied, infiltration process and drying process of the present invention. In this case, for example, even if the refractive index anisotropic material contained in the retardation reinforcing region forming coating liquid does not have a polymerizable functional group, the material having a polymerizable functional group at the side closer to the surface of the resin substrate polymerizes and fixes so that exudation of the refractive index anisotropic material can be prevented and resistance and stability of a film are imparted.

### 2. Second Embodiment

The second embodiment of a method for producing a retardation film of the present invention is an embodiment that a coating liquid comprising a solvent and a material having refractive index anisotropy dissolved or dispersed therein is applied on a long continuous resin substrate via other layer.

As a case that the coating liquid is applied on the long continuous resin substrate via other layer, for example, there may be a case that an orientation layer forming process, wherein an orientation layer is formed on the resin substrate before the coating process, is performed to form the orientation layer on the long continuous resin substrate, and then the coating liquid is applied on the orientation layer. Herein, the orientation layer means a layer which has a function to orient the refractive index anisotropic material in the layer containing the refractive index anisotropic material. In this case, the layer containing the refractive index anisotropic material is formed on the orientation layer and a refractive index anisotropic material molecule is oriented in a predetermined direction. Retardation value of a retardation film is mainly changed by the oriented layer containing the refractive index anisotropic material. Thus, the layer containing the refractive index anisotropic material may be hereinafter referred as a retardation layer.

In this embodiment, generally, in order to impart functions as a retardation layer, it is preferable to have an orientation treatment process, wherein the layer containing the refractive index anisotropic material formed on the orientation layer in the coating process is subject to an orientation treatment.

In the second embodiment, the coating liquid comprising a solvent and a material having refractive index anisotropy dissolved or dispersed therein forms the retardation layer on the resin substrate. Thus, the coating liquid of the second embodiment may be hereinafter referred as a retardation layer forming coating liquid.

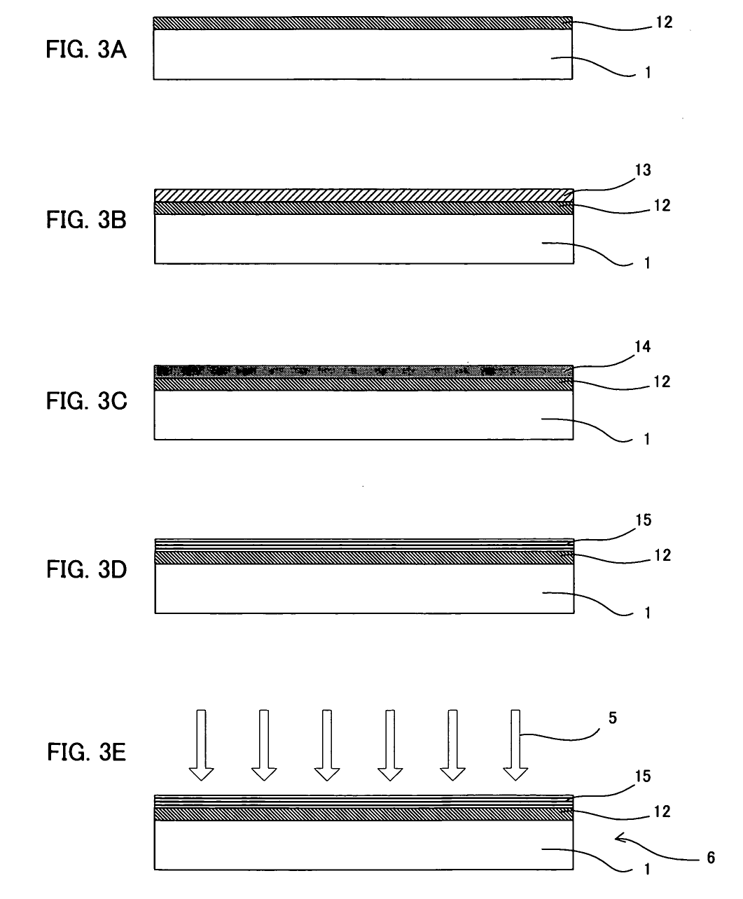

FIGS. 3A to 3E are process diagrams showing an example of a method for producing a retardation film of the present invention. As shown in FIG. 3A, firstly, an orientation layer forming process, wherein an orientation layer 12 is formed on a resin substrate 1, is performed. Next, as shown in FIG. 3B, a coating process, wherein a retardation layer forming coating liquid 13 is applied, is performed. Then, as shown in FIG. 3C, a drying process, wherein a solvent in the retardation layer forming coating liquid applied in the coating process is dried, is performed. The drying process according to the present invention dries at temperature difference of the long continuous resin substrate in width direction within 10° C. at least until a remaining solvent amount in the coating liquid becomes 50 wt % or less. Thereby, an orientation layer 12 is formed on a resin substrate 1, and further a layer containing a refractive index anisotropic material 14 containing a refractive index anisotropic material is formed on the orientation layer 12. Then, as shown in FIG. 3D, a retardation layer 15 is formed by heating up to the liquid crystalline phase forming temperature followed by cooling with the orientation state maintained. Finally, as shown in FIG. 3E, a retardation film 6 is formed by performing a fixing process, wherein the refractive index anisotropic material is polymerized by irradiating with ultraviolet rays 5 from the retardation layer 15 side.

Hereinafter, the second embodiment of the method for producing a retardation film of the present invention will be explained by each step.

(1) Orientation layer forming process

As an orientation layer forming process, there may not be particularly limited but may be a forming process to exhibit an orientation function by a rubbing treatment of an organic compound (preferably a polymer), an oblique evaporation of an inorganic compound, forming of a layer having a microgroove, forming of an organic compound (for example, ω-tricosane acid, dioctadecyl methyl ammonium chloride, methyl stearate) by the Langmuir-Blodgett method (LB film), imparting electric field, imparting magnetic field or light irradiation. Among them, a process of applying an orientation layer forming composition on a long continuous resin substrate, drying a solvent in the orientation layer forming composition and performing a rubbing treatment is preferable.

As the long continuous resin substrate, there may not be particularly limited but the same substrate as that of the first embodiment can be suitably used.

As the orientation layer forming composition, there may not be particularly limited but may be, for example, a compound containing a resin which has already been used as an orientation layer such as PI (polyimide), PVA (polyvinyl alcohol), HEC (hydroxyethyl cellulose), PC (polycarbonate), PS (polystyrene), PMMA (polymethyl methacrylate), PE (polyester), PVCi (polyvinyl cinnamate), PVK (polyvinyl carbazole), polysilane containing cinnamoyl, coumarin, chalcone or the like.

It is preferable that the polymer used for the orientation layer is highly transparent when the polymer is formed into a layer to utilize the layer for an optical element, and is not soluble or is hardly soluble to an organic solvent used for producing a retardation layer. From this point of view, it is preferable to use nonionic water-soluble etherified polysaccharide or water-soluble polysaccharide. Among them, an orientation layer forming composition (1) at least containing nonionic water-soluble etherified polysaccharide and an orientation layer forming composition (2) at least containing a monomer or oligomer having an ethylenically unsaturated bond and water-soluble polysaccharide are preferable from the viewpoint that an orientation layer excellent in adhesion with a retardation layer containing a refractive index anisotropic material formed on the orientation layer can be formed, the refractive index anisotropic material can be easily oriented by the orientation regulating force of the orientation layer by means of a rubbing treatment, and the orientation layer excellent in adhesion with the resin substrate and in resistance can be formed.

As the nonionic water-soluble etherified polysaccharide used for the orientation layer forming composition (1), there may be methyl cellulose, hydroxyethyl cellulose, hydroxypropyl cellulose, hydroxyethylmethyl cellulose, hydroxypropylmethyl cellulose, and hydroxypropyl starch.

As the water-soluble polysaccharide used for the orientation layer forming composition (2), there may be water-soluble cellulose (methyl cellulose, hydroxyethyl cellulose, hydroxypropyl cellulose, hydroxyethylmethyl cellulose, hydroxypropylmethyl cellulose, carboxymethyl cellulose sodium salt, carboxymethyl cellulose ammonium salt and the like), starch, hydroxypropyl starch, carboxymethyl starch, pullulan, chitosan and cyclodextrin.

When polysaccharide used for the orientation layer forming composition, particularly hydroxyethyl cellulose and hydroxypropylmethyl cellulose, is not modified, the orientation layer formed with the use of the polysaccharide is preferable since the orientation layer has a good adhesion with the retardation layer comprising a liquid crystalline compound.

Also, the nonionic water-soluble etherified polysaccharide or the water-soluble polysaccharide used for the orientation layer forming composition is preferable since at least one ethylenically unsaturated bond is introduced so as to improve adhesion with the retardation layer and resistance such as solvent resistance, heat resistance and the like.

Moreover, as the monomer or oligomer having an ethylenically unsaturated bond used for the orientation layer forming composition (2), there may not be particularly limited. The orientation layer forming composition may be obtained by adding one or more kinds of monomers or oligomers having an ethylenically unsaturated bond to polysaccharide. Thereby, a coating layer formed with the use of the orientation layer forming composition can be cured by a ultra-violet irradiation or electron beams radiation. Properties which polysaccharide lacks, that is, property to enhance adhesion with an optically functional layer, and improvement in heat resistance and solvent resistance required can be imparted to thus cured orientation layer. Among them, a monomer or oligomer having multiple ethylenically unsaturated bonds in the molecule is advantageous since crosslinking is sufficient in the curing process by a ultra-violet irradiation or electron beams radiation of the orientation layer so that heat resistance and solvent resistance improve.

The solvent contained in the orientation layer forming compositions (1) and (2) maybe preferably a water/lower alcohol solvent. Herein, the “water/lower alcohol solvent” means that water and/or lower alcohol is a main component and 70 wt % to 100 wt % is water and lower alcohol in total. Any kinds of solvents such as ketones, ethers, esters or the like may be contained if a solvent is compatible with water and lower alcohol and contained by less than 30 wt %. In the present invention, particularly, lower alcohol having defoaming function (methanol and ethanol) or a mixed solvent of water and lower alcohol may be preferable. A ratio of water and lower alcohol may be preferably, water: lower alcohol is 0:100 to 90:10 by weight ratio. Thereby, foaming upon coating can be minimized, and defects of surface of the orientation layer and further a retardation layer can be decreased.

To the orientation layer forming composition, a photo polymerization initiator may be added, if necessary.

As a method of applying the orientation layer forming composition on the long continuous resin substrate, the same method as that mentioned in the coating process of the first embodiment can be used.

As a method of drying the solvent contained in the orientation layer forming composition, there may not be particularly limited. The drying method, wherein the applied solvent in the orientation layer forming composition is dried at temperature difference in width direction of the long continuous resin substrate within 10° C. at least until a remaining solvent amount in the composition becomes 50 wt % or less, is preferable from the view point of uniforming orientation capability.

As a method of the rubbing treatment, there may not be particularly limited. The rubbing treatment is generally performed in such a manner that a rubbing roll, which is produced by attaching a rubbing cloth made of material selected from nylon, polyester, rayon, cotton, polyamide, polymethyl methacrylate and the like on a metal roll with the use of a two-sided tape and the like, is allowed to contact with an orientation layer laminated on a substrate in a rolling state at a high speed, and to move on the substrate.

Also, in the case that the orientation layer forming composition has a polymerizable composition, for example, there may be a process of curing the obtained coating layer by irradiating with ultraviolet rays or electron beams.

The rubbing treatment process may be performed after drying or after curing by irradiating with ultraviolet rays or radiating electron beams.

(2) Coating Process

A coating process in the second embodiment of the present invention is a processs, wherein a coating liquid in which a material in which a refractive index anisotropy is dissolved or dispersed in a solvent, is applied on other layer provided on a long continuous resin substrate, generally applied on an orientation layer.

In the second embodiment of the present invention, it is possible to change a retardation value of the obtained retardation film by changing a kind and a coating amount of a refractive index anisotropic material contained in a retardation layer forming coating liquid in the coating process.

The refractive index anisotropic material contained in the retardation layer forming coating liquid of the second embodiment may not be particularly limited if the material has a double refraction property. Since the refractive index anisotropic material of the second embodiment forms a coating layer without being infiltrated into the resin substrate, the refractive index anisotropic material can be selected and suitably used in accordance with an embodiment of a desired retardation film or a retardation value without particular limitation of a molecular weight or a molecular structure.

As the refractive index anisotropic material, similarly as mentioned in the first embodiment, a liquid crystalline molecule is preferable. A nematic liquid crystalline molecule material, a cholesteric liquid crystalline molecule material, a smectic liquid crystalline molecule material, and a discotic liquid crystalline molecule material can be suitably used. The liquid crystalline molecule may be a polymerizable liquid crystal or a liquid crystal polymer.

For example, in the case of using a retardation film as a negative C plate, a cholesteric liquid crystalline molecule material or a discotic liquid crystalline molecule material can be suitably used.

As the cholesteric liquid crystalline molecule material, there may not be particularly limited. For example, a material which can obtain a chiral nematic liquid crystal (a cholesteric liquid crystal) by adding a chiral agent to a liquid crystalline molecule exhibiting a nematic liquid crystalline phase can be used. A mixed compound of a liquid crystalline molecule and a chiral compound disclosed in JP-A No. Hei. 7-258,638, and Japanese translation of PCT international application Nos. Hei. 11-513,019, 9-506,088and 10-508,882can be used. As the liquid crystalline molecule in this case, the compounds represented by formulae (1) to (17) exemplified in the first embodiment and the nematic liquid crystalline molecule can also be suitably used.

Also, as the chiral agent, it is preferable to use the compound represented by the formulae (18) to (20). In the case of the chiral agent represented by the formulae (18) and (19), “X” may be preferably 2 to 12 (integer). In the case of the chiral agent represented by the formula (20), “X” may be preferably 2 to 5 (integer). Herein, in the formula (18), R¹ refers to hydrogen or a methyl group.

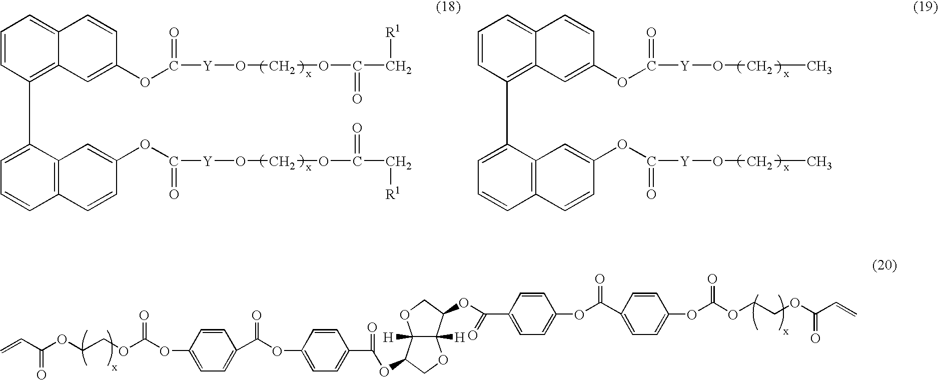

Moreover, as the polymerizable oligomer, a cyclic organopolysiloxane compound having a cholesteric phase as disclosed in JP-A No. Sho. 57-165,480 or the like may be used.

Further, as the liquid crystal polymer, a polymer having a mesogen group exhibiting liquid crystal introduced to a principal chain, a side chain, or both principal and side chains, a polymer cholesteric liquid crystal having a cholesteryl group introduced to a side chain, a liquid crystal polymer disclosed in JP-A No. 9-133,810, a liquid crystal polymer disclosed in JP-A No. 11-293,252 or the like can be used.

On the other hand, as the discotic liquid crystalline molecule material, for example, materials disclosed in C. Destrade et al., Mol. Crysr. Liq. Cryst., vol. 71, page 111 (1981); The Chemical Society of Japan, Quarterly Review of Chemistry, No. 22, Chemistry of Liquid Crystal, 5^{th} Chapter, 10^{th} Chapter, 2^{nd} Section (1994); B. Kohne et al., Angew. Chem. Soc. Chem. Comm., page 1,794 (1985); J. Zhang et al., J. Am. Chem. Soc., vol. 116, page 2,655 (1994) or the like can be used. It is preferable that the discotic liquid crystalline molecule also has a polymerizable functional group. However, if the polymerizable functional group is directly bonded to a disc like core, it is difficult to maintain an orientation state in a polymerization reaction. Thus, a discotic liquid crystalline molecule having a divalent bonded group selected from the group consisting of an alkylene group, an alkenylene group, an arylene group, —CO—, —NH—, —O—, —S— and a combination thereof introduced between the disc like core and the polymerizable functional group is preferable. As the polymerizable functional group, a similar group explained in the first embodiment can be suitably used. Also, as the disk like core, the following may be exemplified. In each example, LQ (or QL) refers to a combination of a divalent bonded group (L) and a polymerizable group (Q).

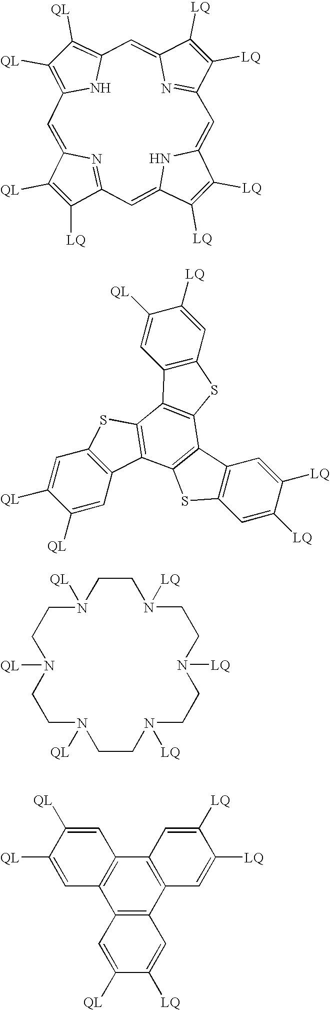

Besides the refractive index anisotropic material, a chiral agent, a photo polymerization initiator, a surfactant, a polymerizable monomer (for example, a compound having a vinyl group, a vinyloxy group, an acryloyl group and a methacryloyl group) and a polymer may be accordingly added to the retardation layer forming coating liquid of the second embodiment as long as orientation of the refractive index anisotropic material is not disturbed. By selecting the surfactant, the polymerizable monomer and the polymer, a gradient angle of a liquid crystal on the surface side (air side) can be adjusted.

As the solvent used for the retardation layer forming coating liquid of the second embodiment, there may not be particularly limited as long as a solvent can be dissolved or dispersed by the refractive index anisotropic material and other components, and does not disturb the orientation of the orientation layer.

The concentration of the refractive index anisotropic material in the solvent in the retardation layer forming coating liquid of the second embodiment of the present invention may not be particularly limited. Generally, the concentration of the refractive index anisotropic material is preferable in the range of 5 wt % to 50 wt %, and particularly in the range of 15 wt % to 30 wt %.

Moreover, although the coating amount onto the resin substrate of the second embodiment differs depending on the retardation value required for a retardation film to be obtained, it is preferable that the coating amount of the refractive index anisotropic material after drying is in the range of 0.8 g/m² to 8 g/m², and particularly preferably in the range of 1.6 g/m² to 5 g/m².

The coating method of the present process can be used similarly to that of the first embodiment mentioned above.

(3) Drying Process

A drying process is a process, wherein the solvent in temperature difference of the long continuous resin substrate in width direction within 10° C. at least until a remaining solvent amount in the coating liquid becomes 50 wt % or less. The drying pocess can be performed similarily to that of the first embodiment mentioned above.

(4) Orientation Treatment Process

An orientation treatment process is a process, wherein a refractive index anisotropic material can be orientation regulating force of an orientation layer. For example, the refractive index anisotropic material can be oriented by heating up to the liquid crystal phase forming temperature or the like.

(5) Fixing Process

A fixing process in the second embodiment is a process, wherein an orientation state of a refractive index anisotropic material is fixed. For example, the fixing process may be performed in such a manner that polymerizing a polymerizable functional group of a refractive index anisotropic material is performed or cooling is performed with an orientation state maintained after heating up to the liquid crystal phase transition temperature to orient. As a method for polymerizing the polymerizable functional group of the refractive index anisotropic material, the similar method as that of the fixing process in the first embodiment can be used.

As described above, the method of producing a retardation film of the present invention has an effect of providing a retardation film having a small fluctuation of the optical compensation property which can be relatively easily produced.

B. Retardation Film

A retardation film according to the present invention is a retardation film having a layer containing a refractive index anisotropic material, wherein the layer is formed in such a manner that after applying a coating liquid comprising a solvent and a material having refractive index anisotropy dissolved or dispersed therein on a resin substrate, the solvent in the coating liquid is dried, and has the remaining solvent amount of 50 wt % or less.

The retardation film of the present invention adjusts a retardation value by having the layer containing the refractive index anisotropic material, wherein the layer is formed in such a manner that after applying a coating liquid comprising a solvent and a material having refractive index anisotropy dissolved or dispersed therein on a resin substrate, the solvent in the coating liquid is dried, and has the remaining solvent amount of 50 wt % or less In this way of adjusting the retardation value, since the layer containing the refractive index anisotropic material can be formed uniformly, more uniform retardation over the whole area of the film plane can be obtained than a case of adjusting a retardation value only by stretching a retardation film. Furthermore, when the remaining solvent amount is high, a surface of a side having the layer containing the refractive index anisotropic material is fogged so that the light transmittance of the film may be lowered. However, the retardation film according to the present invention has the layer containing the refractive index anisotropic material, a remaining solvent amount of which is 50 wt % or less, hence, the retardation film according to the present invention can lower a haze value of the surface of the side having the layer containing the refractive index anisotropic material and prevent decrease of the light transmittance so as to have a high transparency. From the viewpoint of improving transparency even more, the remaining solvent amount of the layer containing the refractive index anisotropic material may be preferably 10 wt % or less, more preferably 1 wt % or less.

In the retardation film according to the present invention, it is preferable that the fluctuation of an in-plane retardation (Re) of the retardation film measured at 550 nm wavelength in any direction parallel to a film surface is within the range of ±5 nm based on the average Re value, and the fluctuation of the thickness direction retardation (Rth) of the retardation film measured at 550 nm wavelength in any direction parallel to the film surface is within the range of ±5 nm based on the average Rth value. In the retardation film of the present invention, since the retardation value is mainly adjusted by the material having refractive index anisotropy contained in the layer containing the refractive index anisotropic material formed by coating, the fluctuation in any direction parallel to the film surface can be made smaller than a case of adjusting a retardation value only by stretching a retardation film. In the case that the retardation value is adjusted only by stretching a retardation film, it is extremely difficult to obtain a uniform retardation over the whole area of the film plane. Thus, usually, the end area of the retardation film cannot be used. Since the fluctuation of the retardation can be made smaller according to the retardation film of the present invention, for example, in the case of applying the retardation film to a display device as an optical compensating film, the optical compensation is carried out uniformly in the display screen so that a display device having an excellent display quality in the view angle or the like can be obtained.

As mentioned above, in order to decrease fluctuation of retardation, it is preferable that the retardation film according to the present invention has the layer containing the refractive index anisotropic material formed in such a manner that after applying a coating liquid comprising a solvent and a material having refractive index anisotropy dissolved or dispersed therein on a resin substrate, the solvent in the coating liquid is dried at temperature difference of the long continuous resin substrate in width direction within 10° C. at least until a remaining solvent amount in the coating liquid becomes 50 wt % or less. This is because since the temperature difference of the long continuous resin substrate is controlled in the width direction to form the layer containing the refractive index anisotropic material, the in-plane orientation of the material having refractive index anisotropy can be uniform, and fluctuation of an optical compensation property of the retardation film can be particularly small.

Herein, the in-plane retardation is represented by Re [nm]=(nx−ny)×d (d: thickness), in which “nx” is a refractive index along a slow axis direction of in-plane direction of the film (the direction to have the largest refractive index in the film plane), “ny” is a refractive index along a fast axis direction of in-plane of the film (the direction to have the smallest refractive index in the film plane), “nz” is a refractive index along a thickness direction of the film. The thickness direction retardation can be represented by Rth [nm]={(nx+ny)/2−nz}×d (d: thickness).

Moreover, the fluctuation of the in-plane and thickness direction retardations in any direction parallel to the film surface can be evaluated, for example, as follows. The in-plane and thickness direction retardations are measured over the whole area of the film plane for a predetermined interval. The average value can be calculated from the measured values, and the fluctuation can be calculated by subtracting the average value from each of the values measured at predetermined intervals. When the film is a long continuous film and the manufacturing condition thereof is not changed according to the time, since it can be assumed that the in-plane and the thickness direction retardations in the longitudinal direction are constant, the fluctuation can be calculated by measuring the in-plane and the thickness direction retardations in the width direction perpendicular to the longitudinal direction at predetermined intervals, calculating the average value from the measured values, and subtracting the average value from each of the values measured at predetermined intervals.

The retardation film of the present invention can be formed by a method similar to the method for producing the retardation film of the present invention.

As embodiments of the present invention, as mentioned in the production method of a retardation film of the present invention, there are two different embodiments depending on where to apply the coating liquid on the resin substrate. Each embodiment of the retardation film of the present invention will be hereinafter explained.

### 1. First Embodiment

A first embodiment of the retardation film of the present invention is an embodiment, wherein the layer containing the refractive index anisotropic material formed in such a manner that after applying a coating liquid comprising a solvent and a material having refractive index anisotropy dissolved or dispersed therein directly on a resin substrate, the solvent in the coating liquid is dried. That is, the first embodiment of the retardation film of the present invention is an embodiment, wherein the above-mentioned layer containing the refractive index anisotropic material is formed in the long continuous resin substrate, which corresponds to the first embodiment of the method for producing the retardation film of the present invention. The first embodiment of the retardation film of the present invention can obtain the same effect as that of the retardation film obtained by the first embodiment of the above-mentioned production method.

In the case that the layer containing the refractive index anisotropic material is formed in the resin substrate, the material having refractive index anisotropy has a concentration gradient in the thickness direction of the resin substrate. The concentration gradient in the present invention includes, if the concentrations of two points in the thickness direction are different, the case that the refractive index anisotropic material is present in a partial region but the refractive index anisotropic material is not present in other region.

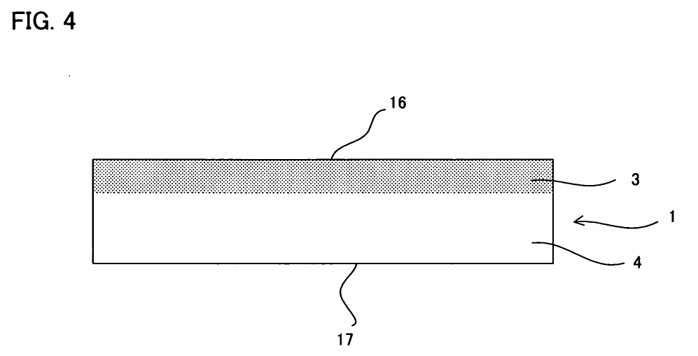

FIG. 4 is a cross-sectional view showing an example of the first embodiment of the retardation film of the present invention. In the example as shown in FIG. 4, a retardation reinforcing region 3 containing a refractive index anisotropic material is formed on one surface side of a resin substrate 1. The concentration gradient of the refractive index anisotropic material in this case is in such a manner that the concentration is high at the surface 16 side to which the retardation reinforcing region 3 is formed, but the surface 17 side to which the retardation reinforcing region is not formed is a substrate region 4 and the refractive index anisotropic material is not contained.

In the first embodiment of the retardation film of the present invention, the retardation reinforcing region having a refractive index anisotropic material in the resin substrate is formed and the concentration gradient of the refractive index anisotropic material is formed. Thus, the retardation reinforcing region reinforces the function as a retardation layer so that it is possible to exhibit various optical functions based on the double refraction property. For example, in the case of using TAC (cellulose triacetate) functioning as a negative C plate as a resin substrate and a liquid crystal material having a molecular structure in a form of a rod as a refractive index anisotropic material, the retardation reinforcing region reinforces the function as a negative C plate so that the retardation film of the present invention has a function as a negative C plate reinforced.

In the first embodiment of the retardation film of the present invention, in the case that the coating liquid containing a refractive index anisotropic material is only applied on one surface of the resin substrate, the concentration gradient of the refractive index anisotropic material is high in concentration at one surface side of the resin substrate and the concentration lowers toward the other surface side (Embodiment A). In the case that the coating liquid containing a refractive index anisotropic material is applied on both surfaces of the resin substrate, the concentration gradient of the refractive index anisotropic material is high in concentration at both surface sides of the resin substrate and the concentration lowers toward the center part (Embodiment B).

Embodiment A is characterized in that a retardation reinforcing region containing a refractive index anisotropic material is formed on one surface side of a resin substrate. The concentration gradient of the refractive index anisotropic material in the retardation reinforcing region is generally high in concentration at the surface side of the resin substrate and low in concentration at the center side in the thickness direction of the resin substrate. On the other surface side of the resin substrate, a substrate region, which does not contain the refractive index anisotropic material, is formed.

The present embodiment is an embodiment that the retardation reinforcing region is formed on one surface side of the resin substrate as mentioned above, thus, the present embodiment has the following advantages.

That is, since the substrate region side does not contain the refractive index anisotropic material, property of the resin substrate is remained. Since there is the substrate region not containing the refractive index anisotropic material, for example, there is an advantage that, in the case that adhesion of the resin substrate itself is good or the like, a polarizing film can be easily provided by attaching a polarizing plate on the substrate region side or the like. Also, the retardation reinforcing region containing the refractive index anisotropic material may lower in strength, however, there is an advantage that strength as a retardation film can be maintained by having the above-mentioned substrate region.

It is preferable that the thickness of the retardation reinforcing region of the present invention is generally in the range of 0.5 μm to 8 μm, particularly 1 μm to 4 μm. If the thickness is smaller than the above range, a sufficient retardation value cannot be obtained. Also, it is difficult to increase the thickness over the above range.

Moreover, in the case of Embodiment A of the first embodiment, it is preferable that the contact angles of the above-mentioned retardation film with respect to pure water are different between one surface and the other surface. With such a constitution, for example, in the case of providing a polarizing film by directly attaching a hydrophilic resin based polarizing layer having a PVA substrate onto the retardation film, if the polarizing layer is attached on the surface having a lower contact angle, a polarizing film can be obtained without inhibiting the adhesion even in the case that a water based adhesive is used.

In the present invention, the difference of the contact angles of one surface and the other surface of the retardation film with respect to pure water is preferably 2 degrees or more, more preferably 4 degrees or more, and particularly preferably 5 degrees or more.

Embodiment B is an embodiment that the concentration gradient of the refractive index anisotropic material in the thickness direction of the resin substrate is high in concentration at both surface sides of the resin substrate and lowers toward the center part.

Embodiment B is characterized in that a retardation reinforcing region containing a refractive index anisotropic material is formed on both surface sides of a resin substrate. The concentration gradient of the refractive index anisotropic material in the retardation reinforcing region is generally high in concentration at the surface side of the resin substrate and low in concentration in the center side in the thickness direction of the resin substrate. In the center part of the resin substrate in the thickness direction, a substrate region which does not contain the refractive index anisotropic material is formed.

In the embodiment B, as there are the retardation reinforcing region on both surface sides, the retardation value of the retardation reinforcing region is assumed as double of that of Embodiment A. Hence, there is an advantage when the retardation value is not sufficient in Embodiment A and much larger retardation value is required.

Also, the retardation reinforcing region containing the refractive index anisotropic material may lower in strength, however, there is an advantage that strength as a retardation film can be maintained by having the substrate region, the center part of which does not contain the refractive index anisotropic material.

Determination whether a concentration gradient of a refractive index anisotropic material is as that of each embodiment can be made by composition analyses of a retardation reinforcing region and a substrate region.

As a method of composition analysis, there maybe a method, wherein with a retardation film cut by the GSP (gradient shaving preparation) so as to provide the cross section in the thickness direction, the concentration distribution of the material in the thickness direction in the cut surface can be measured using a Time of Flight Secondary Ion Mass Spectrometry (TOF-SIMS), or the like.

As the Time of Flight Secondary Ion Mass Spectrometry (TOF-SIMS), for example, there may be used TFS-2000 manufactured by Physical electronics Corp. as the Time of Flight Secondary Ion Mass Spectrometry in condition of, for example, Ga⁺ as the primary ion species, the primary ion energy of 25 kV and the post stage acceleration of 5 kV, and the positive and/or negative secondary ion of cross section in the thickness direction of the retardation film can be measured. In this case, the concentration distribution in the thickness direction of the refractive index anisotropic material can be obtained by plotting the secondary ion strength due to the refractive index anisotropic material with respect to the thickness direction. When the secondary ion strength due to the substrate film is similarly plotted with respect to the thickness direction, the relative concentration change of the refractive index anisotropic material and the substrate film can be obtained. As the secondary ion due to the refractive index anisotropic material, for example, a total of relatively strongly observed secondary ion at a surface or a part wherein the refractive index anisotropic material is assumed to be filled by analysis such as a cross sectional TEM observation or the like. As the secondary ion due to the substrate film, for example, a total of relatively strongly observed secondary ion at a surface or a part wherein the refractive index anisotropic material is assumed to be not filled by analysis such as a cross sectional TEM observation or the like.

In the present invention, in any of the above embodiments, it is preferable that the concentration gradient in the thickness direction of the resin substrate of the material having refractive index anisotropy continuously changes. In this case, in comparison with the case that the concentration in a thickness changes not continuously, stress does not concentrate to a specific interface in the layer, thus delamination strength becomes stronger and reliabilities such as heat resistance, water resistance (durability in terms of the delamination of interface with respect to repetition of the coldness and the heat in the use environment or contact with water) and the like becomes higher.

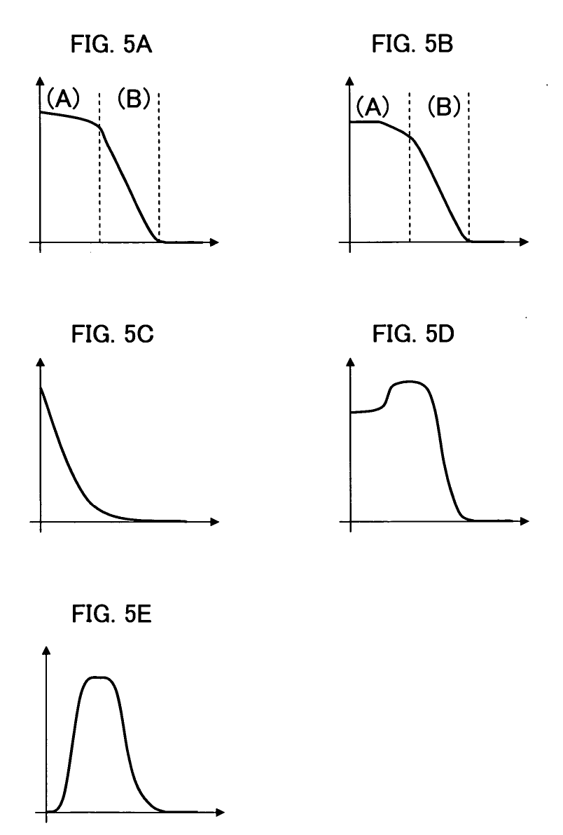

Herein, the concentration gradient continuously change refers to the case that the concentration change is continuous in the thickness direction when taking the concentration as a vertical axis and the thickness direction as a horizontal axis as for example shown in FIGS. 5A to 5E.

Moreover, in the present invention, it is preferable to have a region in which the concentration gradient of the material having refractive index anisotropy is gentle and a region in which the concentration gradient of the material having refractive index anisotropy is steep. In this case, the reliability can be improved while providing a desired retardation by concentrating a sufficient amount of the material having refractive index anisotropy in a concentration region gradient having a high concentration and a gentle concentration gradient to ensure a sufficient retardation value therein, and furthermore, by linking continuously the concentration from the high concentration region to the low concentration region in the steep concentration gradient region so that the stress concentration to a specific interface of the layer can be prevented.

In the present invention, the gentle and steep concentration gradient refers to a relative relationship of the concentration gradient distribution of the material having refractive index anisotropy in the thickness direction. The region of gentle concentration gradient and the region of steep concentration gradient are relatively classified macroscopically as a region having the concentration gradient continuously in a small value and a region having the same continuously in a large value. In this case, the region of gentle concentration gradient includes a region of constant concentration gradient. In the present invention, as the region of gentle concentration gradient, there may be the case wherein the concentration of the refractive index anisotropic material is relatively high and the refractive index anisotropic material is filled in the resin substrate at the concentration close to saturation such as a region (A) as shown in FIG. 5A and a region (A) as shown in FIG. 5B. Also in the present invention, as the region of steep concentration gradient, there may be a region wherein a region containing relatively high concentration of the refractive index anisotropic material transits to a substrate region not containing the refractive index anisotropic material such as a region (B) as shown in FIG. 5A and a region (B) as shown in FIG. 5B. When high retardation value is required, the concentration gradient as shown in FIGS. 5A and 5B is generally preferable. However, when the high retardation value is not particularly required, as shown in FIG. 5C, an embodiment which a region of steep concentration gradient transiting from a high concentration to a low concentration toward the central part formed in the vicinity of the polymer film surface with the refractive index anisotropic material filled in a high concentration, and a region of gentle concentration gradient with the refractive index anisotropic material filled in a low concentration formed on the central part are provided continuously may be employed.

### 2. Second Embodiment

A second embodiment of a retardation film of the present invention is an embodiment, wherein the layer containing the refractive index anisotropic material formed in such a manner that after applying a coating liquid comprising a solvent and a material having refractive index anisotropy dissolved or dispersed therein on a resin substrate via other layer, the solvent in the coating liquid is dried. That is, the second embodiment of the retardation film of the present invention is an embodiment, wherein the above-mentioned refractive index anisotropic material containing layer is formed on an orientation layer on the above-mentioned resin substrate, which corresponds to the second embodiment of the method for producing the retardation film of the present invention. The same effect can be obtained as that of the retardation film obtained by the second embodiment of the above-mentioned production method.

In this case, the retardation value of the retardation film can be mainly changed by the layer containing the refractive index anisotropic material.

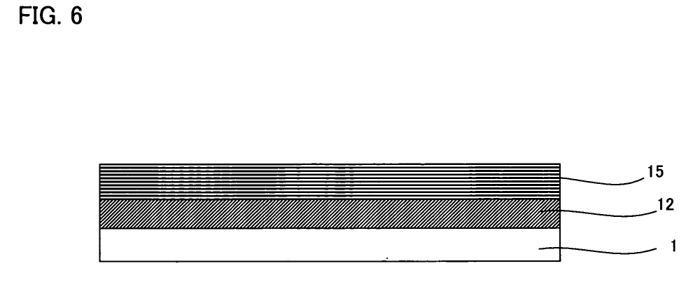

FIG. 6 is a cross-sectional view showing an example of the second embodiment of the retardation film of the present invention. In the example shown in FIG. 6, an orientation layer 12 and a retardation layer 15 containing a refractive index anisotropic material are laminated in this order on a resin substrate 1.

The same resin substrate 1, orientation layer 12 and retardation layer 15 can be used as those mentioned in the method for producing the retardation film as mentioned above, thus, explanations thereof are omitted herein. Another functional layer such as a primer layer (adhesion layer), a protection layer or the like may be provided between the resin substrate 1 and the orientation layer 12. Not only one retardation layer 15 but also two or more retardation layers may be provided. The layer constitution may not be particularly limited.

In the second embodiment of the retardation film of the present invention, there is a merit that a uniform view angle viewed from any angle can be compensated by selecting the refractive index anisotropic material accordingly, adjusting the coating amount of the refractive index anisotropic material accordingly, controlling the temperature at the time of coating, which is a feature of the present invention as mentioned above, and forming an even coating layer so that the retardation layer 15 containing the refractive index anisotropic material on the orientation layer 12 exhibits the retardation function.

3. Retardation Film

It is preferable that the retardation value, in the visible light range, of the retardation film of the present invention on the shorter wavelength side is larger than that of the longer wavelength side. In general, the retardation value of a liquid crystal material used for a liquid crystal layer of a liquid crystal display, in the visible light range, on the shorter wavelength side is larger than that of the longer wavelength side. Therefore, in the case of using the retardation film of the present invention as, for example, an optical compensating plate, there is an advantage that the compensation can be carried out in all wavelength range in the visible light range.

In order to make the retardation value in the visible light range of the retardation film larger on the shorter wavelength side than that of the longer wavelength side, it is preferable to select a resin substrate and a refractive index anisotropic material having larger retardation value in the visible light range on the shorter wavelength side than that of the longer wavelength side. However, since the TAC film, used for the protecting film of the polarizing layer (such as a polyvinyl alcohol (PVA)) does not have such a retardation value, it is preferable to select a refractive index anisotropic material having the above-mentioned retardation value.

Also, the retardation film of the present invention may further have other layers laminated directly. For example, when the retardation value is insufficient as a retardation film, another retardation layer may further be laminated directly on the retardation film. Moreover, as it will be described later, other optical functional layers, for example, a polarizing layer may be laminated directly.

4. Application

The retardation film of the present invention can be used for various applications as an optical functional film. Specifically, there may be an optical compensating plate (for example, a viewing angle compensating plate), an elliptical polarizing plate, a brightness improving plate and the like.

In the present invention, the application as the optical compensating plate is particularly suitable. Specifically, the retardation film can be used for an application as a negative C plate by using a TAC film as the resin substrate, using a liquid crystalline compound, whose molecular structure is in a shape of a rod, as the refractive index anisotropic material in the first embodiment of a retardation film of the present invention.

Moreover, the retardation film of the present invention can be used as various optical functional films used for a liquid crystal display. For example, when the retardation film of the present invention is used as the optical compensating plate having the function of a negative C plate as mentioned above, it can be suitably used for a liquid crystal display having a VA mode or OCB mode liquid crystal layer.

The present invention may not be limited to the above-mentioned embodiments. The embodiments are given solely for the purpose of illustration. Any invention which has the substantially same constitution as the technical idea mentioned in claims of the present invention and has the same operation and effect as the present invention is within the scope of the present invention.

### EXAMPLES

Hereinafter, the present invention will be explained specifically with reference to the examples.

### (Example 1)

As a refractive index anisotropic material, a photo polymerizable liquid crystal compound (the below-mentioned compound (1)) was dissolved in cyclohexanone by 20 wt %. Therein, a photo polymerization initiator (Irgacure907, manufactured by Nihon Ciba-Geigy K. K.) of 1 wt % with respect to the weight of the photo polymerizable liquid crystal compound was added, thus obtained a coating liquid. The coating liquid was applied on a TAC film for a continuous conveyance having a thickness of 80 μm and a width of 1,450 mm by a slit reverse so as to have a 2.5 g/m² coating amount after drying. Next, the solvent was dried by means of a drying zone 11(1), 11(2), 11(3), schematically shown in FIG. 2B, wherein a drying temperature difference is larger than 10° C. in the substrate conveying direction but a temperature difference is within 10° C. in the substrate width direction. Then, by irradiating the coated surface with 100 mJ/cm² of ultraviolet ray under nitrogen atmosphere to cure, the above-mentioned photo polymerizable liquid crystal compound was fixed to produce a retardation film. The obtained retardation film was used as a sample and evaluated for the below-mentioned items. 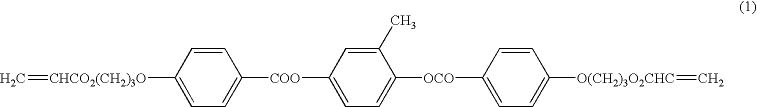
1. Optical Characteristics

An in-plane retardation (Re) and a thickness direction retardation (Rth) at 550 nm wavelength of the produced retardation film were measured by means of an automatic birefringence measuring apparatus (product name: KOBRA-21ADH, manufactured by Oji Scientific Instruments). Since the production condition in terms of time was not changed, the in-plane retardation and the thickness direction retardation in the longitudinal direction can be assumed to be constant. In this condition, the in-plane retardation and the thickness direction retardation of whole width in the width direction perpendicular to the longitudinal direction was measured at every 30 mm. A mean value was calculated from the measured values. Fluctuations were calculated by subtracting the mean value from each measured value measured at every 30 mm.

TABLE 1

| | | | | Comparative | Comparative |
|---|---|---|---|---|---|
| | | Example 1 | Example 2 | example 1 | example 2 |
| In-plane | Mean value (nm) | 1 | 1 | 2 | 1.5 |
| retardation (Re) | Fluctuation range (nm) | −1˜+1 | −1˜+1 | −1˜+1 | −1˜+1 |
| Thickness direction | Mean value (nm) | 130 | 135 | 120 | 120 |
| retardation (Rth) | Fluctuation range (nm) | −2˜+3 | −3˜+1 | −7˜+6 | −6˜+10 |

2. Cross Section Observation by TEM

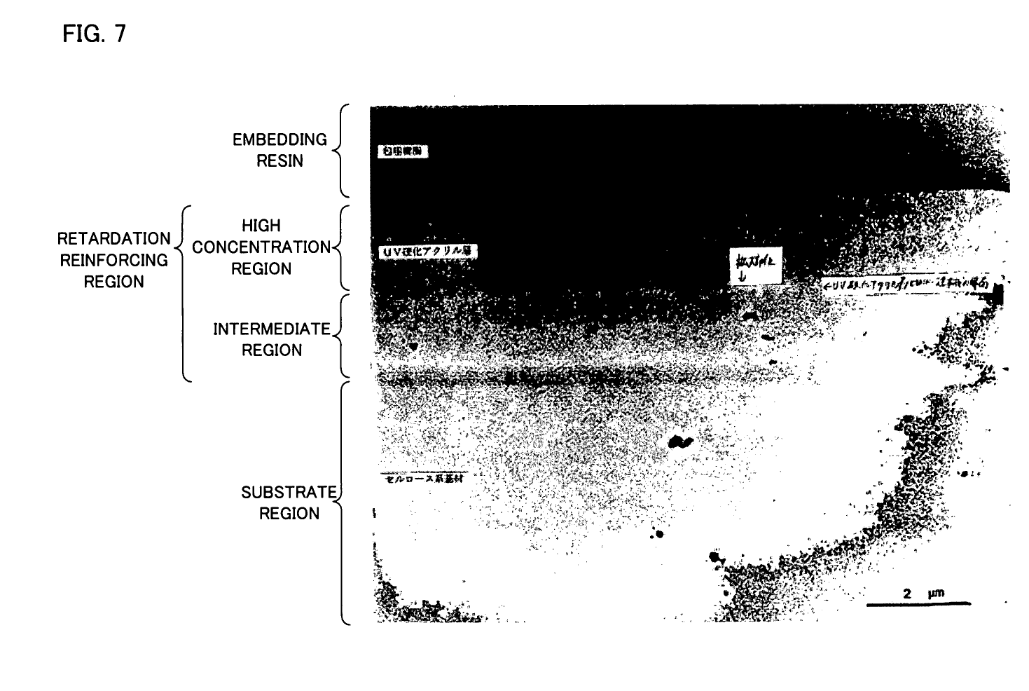

A surface protection of a liquid crystal coated surface of the sample was carried out by coating with metal oxide. After embedding the sample with an epoxy resin, it was bonded onto a cryo supporting platform. Then, the sample was trimmed and figured by a cryo system with a diamond knife installed ultra microtome. The sample was subjected to a vapor dying by metal oxide, an ultra thin piece was produced, and then, the TEM observation was carried out. Results are shown in FIG. 7. As it is apparent from FIG. 7, it was found out that the refractive index anisotropic material was infiltrated in the resin substrate which was coated with the refractive index anisotropic material of the sample, and the infiltrated side was separated into three layers (a high concentration region out of the retardation reinforcing region, an intermediate region out of the retardation reinforcing region, and a base material region).

3. Haze To examine transparency of the sample, the haze value was measured by a turbidimeter (product name: NDH2000, manufactured by Nippon Denshoku Industries Co., Ltd.). The result was 0.35%, which is preferable.

4. Adhesion Test

To examine adhesion, a peeling test was carried out in the following manner. Cuts of 1 mm width grid were made on the obtained sample. An adhesive tape (Sellotape (registered trademark), manufactured by NICHIBAN CO., LTD.) was affixed on a liquid crystal surface of the sample. Then, the tape was peeled off to observe visually. As a result, the adhesion degree was 100%.
Adhesion degree (%)=(part which was not peeled off/ region where tape was affixed)×100
5. Humidity and Heat Resistance Test

After soaking the sample in hot water of 90° C. for 60 minutes, optical characteristics and adhesion were measured by the above-mentioned methods. As a result, comparing before and after the test, no change of the optical characteristics and the adhesion was observed.

6. Water Resistance Test

After soaking the sample in pure water for one day under room temperature (23.5° C.), optical characteristics and adhesion were measured by the above-mentioned methods. As a result, comparing before and after the test, no change of the optical characteristics and the adhesion was observed.

7. Contact Angle Measurement

The contact angles of the retardation reinforcing region surface, in which the coating liquid was applied, and the substrate region surface, in which the coating liquid was not applied, of the retardation film were measured. Specifically, the contact angles of the retardation reinforcing region surface and the substrate region surface (TAC surface) to pure water were measured by means of a contact angle measuring device (CA-Z type, manufactured by Kyowa Interface Science Co., LTD.). The contact angle was measured 30 seconds after dropping 0.1 ml of pure water onto the measuring surface. As a result, the contact angle of the retardation reinforcing region surface was 62.6° and the contact angle of the substrate region surface was 57.3°. The retardation reinforcing region surface has a higher value, leading to a result that the surface of the region other than the retardation reinforcing region has higher hydrophilic property.

### (Example 2)

Except that the solvent was dried by means of a drying zone 7, 10(1), 10(2), 10(3), schematically shown in FIG. 2A, wherein a temperature difference was within 10° C. in the substrate width direction until the remaining solvent amount became 50 wt % or less, and a temperature difference was larger than 10° C. in the substrate width direction in the area where the remaining solvent amount was less than 50 wt %, a retardation film was produced similarly as Example 1. The optical measurement was carried out similarly as Example 1.

### (Comparative Example 1)

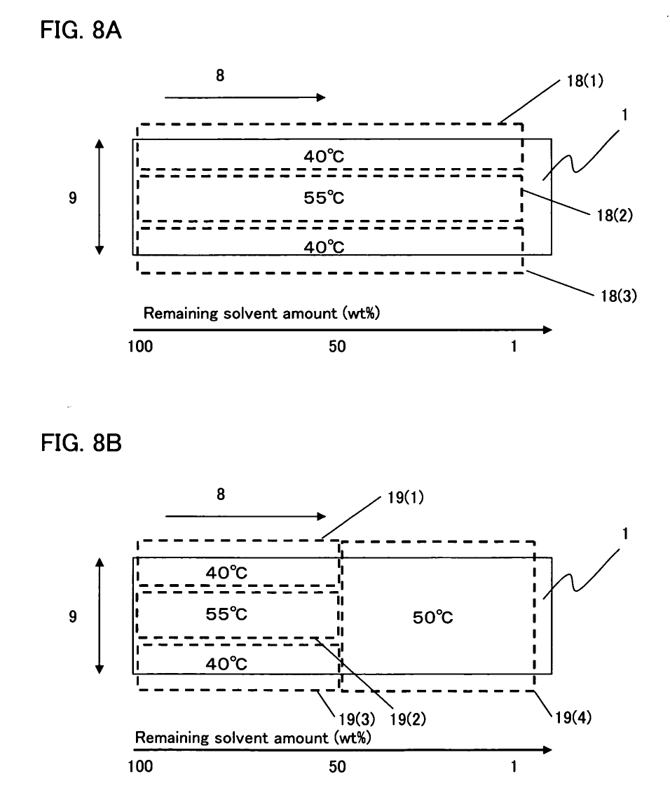

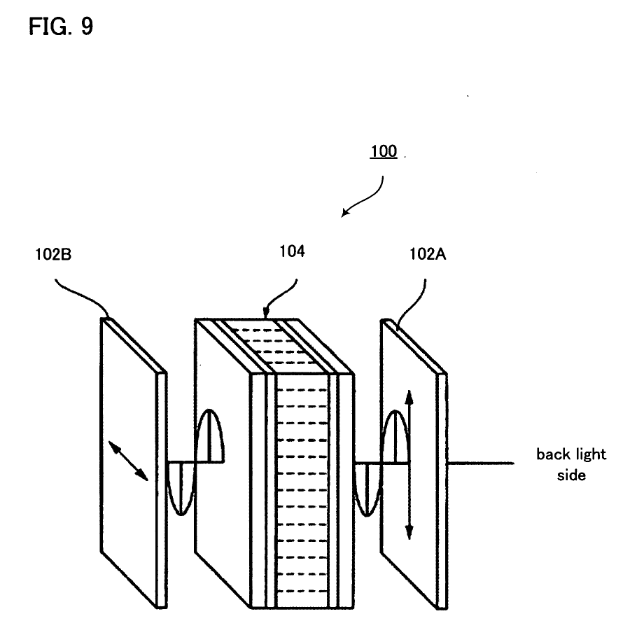

Except that the solvent was dried by means of a drying zone 18(1), 18(2), 18(3), schematically shown in FIG. 8A, wherein a temperature difference was within 10° C. in the substrate conveying direction, and a temperature difference was larger than 10° C. in the substrate width direction, a retardation film was produced similarly as Example 1. The optical measurement was carried out similarly as Example 1.

### (Comparative Example 2)

Except that the solvent was dried by means of a drying zone 19(1), 19(2), 19(3), 19(4), schematically shown in FIG. 8B, wherein a temperature difference was larger than 10° C. in the substrate width direction until the remaining solvent amount became 50 wt % or less, and a temperature difference was within 10° C. in the substrate width direction in the area where the remaining solvent amount was less than 50 wt %, a retardation film was produced similarly as Example 1. The optical measurement was carried out similarly as Example 1.

1. A method for producing a retardation film comprising:
a coating process, wherein a coating liquid comprising a solvent and a material having refractive index anisotropy dissolved or dispersed therein is applied on a long continuous resin substrate; and
a drying process, wherein the solvent in the coating liquid applied in the coating process is dried at temperature difference of the long continuous resin substrate in width direction within 10° C. at least until a remaining solvent amount in the coating liquid becomes 50 wt % or less.

2. A method for producing a retardation film according to claim 1, further comprising an infiltration process, wherein a material having refractive index anisotropy is infiltrated into the long continuous resin substrate.

3. A method for producing a retardation film according to claim 2, further comprising a fixing process, wherein the material having refractive Index anisotropy infiltrated into the long continuous resin substrate is fixed, after the drying process.

4. A method for producing a retardation film according to claim 1, further comprising an orientation layer forming process, wherein an orientation layer is formed on the long continuous resin substrate, before the coating process.

5. A method for producing a retardation film according to claim 4, further comprising an orientation treatment process, wherein a layer containing a refractive index anisotropic material formed on the orientation layer in the coating process is subject to an orientation treatment.

6. A retardation film having a layer containing a refractive index anisotropic material, wherein the layer is formed in such a manner that after applying a coating liquid comprising a solvent and a material having refractive index anisotropy dissolved or dispersed therein on a resin substrate, the solvent in the coating liquid is dried, and has the remaining solvent amount of 50 wt % or less.

7. A retardation film having a layer containing a refractive index anisotropic material, wherein the layer is formed in such a manner that after applying a coating liquid comprising a solvent and a material having refractive index anisotropy dissolved or dispersed therein on a resin substrate, the solvent in the coating liquid is dried, and has the remaining solvent amount of 10 wt % or less.

8. A retardation film having a layer containing a refractive index anisotropic material, wherein the layer is formed in such a manner that after applying a coating liquid comprising a solvent and a material having refractive index anisotropy dissolved or dispersed therein on a resin substrate, the solvent in the coating liquid is dried, and has the remaining solvent amount of 1 wt % or less.

9. A retardation film according to claim 6, wherein a fluctuation of an in-plane retardation (Re) of the retardation film measured at 550 nm wavelength in any direction parallel to a film surface is within the range of ±5 nm based on the average of the Re, and a fluctuation of a thickness direction retardation (Rth) of the retardation film measured at 550 nm wavelength in any direction parallel to the film surface is within the range of ±5 nm based on the average of the Rth.

10. A retardation film according to claim 6, wherein the layer containing the refractive index anisotropic material is formed in the resin substrate.

11. A retardation film according to claim 10, wherein the refractive index anisotropic material has a concentration gradient in a direction of the thickness of the resin substrate.

12. A retardation film according to claim 6, wherein the layer containing the refractive index anisotropic material is formed on an orientation layer on the resin substrate.

13. A retardation film according to claim 6, wherein the resin substrate has regularity in the refractive index.

14. A retardation film according to claim 6, wherein the refractive Index anisotropic material is a material having liquid crystallinity.

15. A retardation film according to claim 6, wherein a molecular structure of the refractive index anisotropic material is in a shape of a rod.

16. A retardation film according to claim 12, wherein the refractive index anisotropic material has a cholesteric structure or a discotic structure.

17. A retardation film according to claim 6, wherein the refractive index anisotropic material comprises a material having a polymerizable functional group.
